(19) United States
(12) Patent Application Publication
(10) Pub. No.: US 2018/0268732 A1
(43) Pub. Date: Sep. 20, 2018

(54) PHONETIC SYSTEM AND METHOD FOR TEACHING READING

(71) Applicant: John Thiel, Redlands, CA (US)

(72) Inventor: John Thiel, Redlands, CA (US)

(21) Appl. No.: 15/460,110

(22) Filed: Mar. 15, 2017

(51) Int. Cl. G09B 17/02; G09B 5/02

(52) U.S. Cl. CPC G09B 17/02; G09B 5/02

(57) ABSTRACT

A system and method for annotating written materials with phonetic information to indicate correct pronunciation is presented. The system and method of the present invention uses color and makes changes to the standard shapes of letters to indicate the phoneme a letter or group of letters represent. The system and method of the present invention does not add letters, remove letters, or alter the appearance of letters to an extent that would render the written materials unreadable or unrecognizable to a person unfamiliar with the system and method of the present invention. Thus, the system and method of the present invention preserves the overall appearance of written materials while providing additional information that allows a reader trained in the system and method of the present invention to correctly pronounce those written materials.

### BACKGROUND OF THE INVENTION

### (1) Field of the Invention

The present invention relates generally to systems and methods for teaching reading, and more particularly to a system and method for annotating written words to indicate the correct pronunciation of those words for languages that do not use phonetic spelling, such as English.

### (2) Description of the Related Art

Certain languages, such as English, can be difficult for students to learn to read and write because they do not use phonetic spelling. Many, if not most, words are not spelled exactly the way they are pronounced; some words, even short words such as “usual” or “one”, are spelled very differently from the way they are pronounced. To become proficient in reading and writing the language, the student must memorize the correct spelling of thousands of words. Knowing all the spelling rules and exceptions—along with a complete knowledge of phonics—won't guarantee that the student will pronounce a word correctly.

Prior art systems for phonetic spelling have been devised, including general-purpose phonetic transcription systems such as the International Phonetic Alphabet (“IPA”) or the Americanist phonetic notation, as well as phonetic alphabets specifically designed for a particular language, such as Benjamin Franklin's phonetic alphabet or the Shavian alphabet. Prior art phonetic notation systems typically use a unique symbol to represent each phoneme, or perceptually distinct sound, of a language. For example, English has 44 phonemes, so prior art phonetic notation systems such as IPA represent those 44 phonemes with at least 44 distinct symbols (and IPA has many additional symbols to represent other sounds not used in English). However, such prior art phonetic notation systems require that the student learn a completely new set of symbols to represent the phonemes of, e.g., English, and mastery of spelling in prior art phonetic notation systems does not necessarily convey proficiency in conventional English spelling. Furthermore, while IPA is commonly used by academic and professional linguists to accurately transcribe the sounds of speech, it is not understood by most laypeople, and thus an IPA transcription of an English word cannot be assumed to be universally readable by people who can read English.

Alternatively, some prior art phonetic notation systems use a smaller number of distinct symbols and use combinations of those symbols to represent the complete set of phonemes. For example, a phonetic notation system that restricts itself to the 26 letters in the English alphabet must use combinations of two or more letters to represent some of the 44. English phonemes, such as “sh” to represent the IPA sound /∫/. Such informal methods of spelling words “the way they sound” are commonly used by laypeople and commonly found in dictionaries. However, these informal phonetic notation systems are not standardized. Furthermore, as with the above-described standardized prior art phonetic notation systems, mastery of spelling in prior art informal phonetic notation systems does not necessarily convey proficiency in conventional English spelling.

Until now, there has not been a system or method for writing words phonetically that preserves the traditional spelling and appearance of those words, but provides a guide to the pronunciation of those words for students of the language.

### BRIEF SUMMARY OF THE INVENTION

A system and method for annotating written words, phrases, and longer passages (collectively, “written materials”) with phonetic information to indicate the correct pronunciation of those written materials is presented. In one or more embodiments, the system and method of the present invention may be used to teach students how to read and pronounce written materials, particularly for languages that do not use phonetic spelling, such as English. In one or more embodiments, the system and method of the present invention makes changes to the individual letters or letter clusters that represent a phoneme to uniquely identify which phoneme the letter or letters represent in a specific context. In one or more embodiments, the system and method of the present invention uses color to indicate the phoneme a letter or group of letters represent. In one or more embodiments, the system and method of the present invention makes changes to the standard shapes of letters to indicate the phoneme a letter or group of letters represent. Thus, the system and method of the present invention allows the student to correctly pronounce any consonant or vowel (whether monophthong, diphthong, triphthong, or rhotacized) and further indicates “silent” letters that are not pronounced. In one or more embodiments, the system and method of the present invention will provide the correct pronunciation for over 99% of English words.

In one or more embodiments, the system and method of the present invention does not add letters, remove letters, or alter the appearance of letters to an extent that would render the written materials unreadable or unrecognizable to a person unfamiliar with the system and method of the present invention. Thus, the system and method of the present invention preserves the overall appearance of written materials while providing additional information that allows a reader trained in the system and method of the present invention to correctly pronounce those written materials.

In one or more embodiments, the system and method of the present invention is suitable for producing printed materials, such as books, with complete phonetic annotations to teach students how to read and write a language, or alternatively to provide pronunciation guides for select difficult or unusual words. In one or more embodiments, the system and method of the present invention is suitable for implementation on a computer system to annotate any text with phonetic information to assist readers with the correct pronunciation of the text.

The description of the invention herein represents specific sounds with IPA characters between forward slashes; for example, /∫/. Where useful, example words are set forth in quotes and followed by the IPA transcription in forward slashes; for example, “book” / [symbol] / or “function” / [symbol] /.

In one or more embodiments, the system and method of the present invention separates English letters into six categories: (1) silent letters, (2) vowel letters with the schwa (/ [symbol] /) sound, (3) rhotacized or “r-controlled” letter clusters (e.g., / [symbol] / or / [symbol] /) that are not pronounced the way they are spelled, (4) vowel letters that sound like other vowels, (5) vowel letters that represent more than one alternative vowel sound, and (6) consonant letters or letter clusters. Each category is associated with a different type or style of annotation. The categorization of a particular letter or letter cluster is dependent on the context in which they appear and therefore on the phoneme they represent in that context. For example, sometimes the letter “e” is silent (as in “while” / [symbol] /), sometimes it represents the schwa (/ [symbol] /) sound (as in “the” / [symbol] /), and sometimes it represents another vowel sound, such as /ε/, /e/, /ι/, /i/, or /ju/ (as in “bet” /bεt/, “they” / [symbol] /, “estate” / [symbol] /, “England” / [symbol] /, or “few” /fju/, respectively). In one or more embodiments, a letter or letter cluster is not annotated (i.e., retains its standard appearance) when that letter or letter cluster is pronounced in the common or standard way.

### BRIEF DESCRIPTION OF THE DRAWINGS

The present invention may be better understood, and its features made apparent to those skilled in the art by referencing the accompanying drawings.

FIG. 1 shows how silent letters are printed or displayed in an embodiment of the present invention.

FIG. 2 shows how vowel letters with the schwa / [symbol] / sound are printed or displayed in an embodiment of the present invention.

FIGS. 3a-3d show how rhotacized or “r-controlled” letter clusters are printed or displayed in an embodiment of the present invention.

FIGS. 4a-4d show how vowel letters that sound like other vowels are printed or displayed in an embodiment of the present invention.

FIG. 5 shows how “short” vowel letters are printed or displayed in an embodiment of the present invention.

FIG. 6 shows how “long” vowel letters are printed or displayed in an embodiment of the present invention.

FIG. 7 shows how the letters “a” and “o” are printed or displayed when they represent the / [symbol] / sound in an embodiment of the present invention.

FIG. 8 shows how the letters “a” and “o” are printed or displayed when they represent the /a/ sound in an embodiment of the present invention.

FIG. 9 shows how the letters “e”, “o”, and “u” are printed or displayed when they represent the /u:/ sound in an embodiment of the present invention.

FIG. 10 shows how the letters “o” and “u” are printed or displayed when they represent the / [symbol] / sound in an embodiment of the present invention.

FIG. 11 shows how the letters “o” and “u” are printed or displayed when they represent the / [symbol] / sound in an embodiment of the present invention.

FIG. 12 shows how the letter “e” is printed or displayed when it represents the /ju/ sound in an embodiment of the present invention.

FIG. 13 shows how the letter “y” is printed or displayed when it represents the /i/, / [symbol] /, and Id vowel sounds in an embodiment of the present invention.

FIG. 14 shows how the letter “l” is printed or displayed when it represents the / [symbol] / sound in an embodiment of the present invention.

FIG. 15 shows how consonant letters are printed or displayed in an embodiment of the present invention.

FIG. 16 shows how the letter “c” is printed or displayed when it represents the /k/ and /s/ sounds in an embodiment of the present invention.

FIG. 17 shows how the letter “g” is printed or displayed when it represents the / [symbol] / sound in an embodiment of the present invention.

FIG. 18 shows how the letter “s” is printed or displayed when it represents the /z/ sound in an embodiment of the present invention.

FIGS. 19-21 show how the letters “t”, “s”, and “c” are printed or displayed when they represent the /∫/, / [symbol] /, and / [symbol] / sounds in an embodiment of the present invention.

FIG. 22 shows how the letter “i” is printed or displayed when it represents the /j/ sound in an embodiment of the present invention.

FIGS. 23-25 show how the letter “x” is printed or displayed when it represents the /ks/, /gz/, and /z/ sounds in an embodiment of the present invention.

FIG. 26 shows how the letter “d” is printed or displayed when it represents the /t/ sound in an embodiment of the present invention.

FIG. 27 shows how the letter cluster “ng” is printed or displayed when it represents the / [symbol] / and / [symbol] / sounds in an embodiment of the present invention.

FIG. 28 shows how “extra” letters that do not appear in spelling of a word are printed or displayed in superscript in an embodiment of the present invention.

FIG. 29 shows how clusters of related letters are joined by a horizontal line at or near the baseline of the letters in an embodiment of the present invention.

FIGS. 30a-30h are a flow chart illustrating a method for annotating written materials with phonetic information in accordance with an embodiment of the present invention.

FIG. 31 shows several example words annotated using the method of an embodiment of the present invention.

FIGS. 32a-32c are an excerpt from “Robinson Crusoe” annotated using the method of an embodiment of the present invention.

The use of the same reference symbols in different drawings indicates similar or identical items.

### DETAILED DESCRIPTION OF THE INVENTION

A system and method for annotating written words, phrases, and longer passages (collectively, “written materials”) with phonetic information to indicate the correct pronunciation of those written materials is presented. In one or more embodiments, the system and method of the present invention may be used to teach students how to read and pronounce written materials, particularly for languages that do not use phonetic spelling, such as English. In one or more embodiments, the system and method of the present invention makes changes to the individual letters or letter clusters that represent a phoneme to uniquely identify which phoneme the letter or letters represent in a specific context. In one or more embodiments, the system and method of the present invention uses color to indicate the phoneme a letter or group of letters represent. In one or more embodiments, the system and method of the present invention makes changes to the standard shapes of letters to indicate the phoneme a letter or group of letters represent. Thus, the system and method of the present invention allows the student to correctly pronounce any consonant or vowel (whether monophthong, diphthong, triphthong, or rhotacized) and further indicates “silent” letters that are not pronounced. In one or more embodiments, the system and method of the present invention will provide the correct pronunciation for over 99% of English words.

In one or more embodiments, the system and method of the present invention does not add letters, remove letters, or alter the appearance of letters to an extent that would render the written materials unreadable or unrecognizable to a person unfamiliar with the system and method of the present invention. Thus, the system and method of the present invention preserves the overall appearance of written materials while providing additional information that allows a reader trained in the system and method of the present invention to correctly pronounce those written materials.

In one or more embodiments, the system and method of the present invention is suitable for producing printed materials, such as books, with complete phonetic annotations to teach students how to read and write a language, or alternatively to provide pronunciation guides for select difficult or unusual words. In one or more embodiments, the system and method of the present invention is suitable for implementation on a computer system to annotate any text with phonetic information to assist readers with the correct pronunciation of the text.

The description of the invention herein represents specific sounds with IPA characters between forward slashes; for example, /∫/. Where useful, example words are set forth in quotes and followed by the IPA transcription in forward slashes; for example, “book” / [symbol] / or “function” / [symbol] /.

In one or more embodiments, the system and method of the present invention separates English letters into six categories: (1) silent letters, (2) vowel letters with the schwa (/ [symbol] /) sound, (3) rhotacized or “r-controlled” letter clusters (e.g., / [symbol] / or / [symbol] /) that are not pronounced the way they are spelled, (4) vowel letters that sound like other vowels, (5) vowel letters that represent more than one alternative vowel sound, and (6) consonant letters or letter clusters. Each category is associated with a different type or style of annotation. The categorization of a particular letter or letter cluster is dependent on the context in which they appear and therefore on the phoneme they represent in that context. For example, sometimes the letter “e” is silent (as in “while” / [symbol] /), sometimes it represents the schwa / [symbol] / sound (as in “the” / [symbol] /), and sometimes it represents another vowel sound, such as /ε/, /e/, /ι/, /i/, or /ju/ (as in “bet” /bεt/, “they” / [symbol] /, “estate” / [symbol] /, “England” / [symbol] /, or “few” /fju/, respectively).

In one or more embodiments, a letter or letter cluster is not annotated (i.e., retains its standard appearance) when that letter or letter cluster is pronounced in the common or standard way. Table 1 sets forth the English letters and letter clusters that have a standard pronunciation, along with the phonetic transcription in both IPA and in an informal transcription commonly used by English speakers.

TABLE 1
Standard pronunciations of English letters

| English | | |
|---|---|---|
| letter or | IPA | Informal |
| cluster | transcription | transcription |
| b | /b/ | “b” |
| ch | /t∫/ | “ch” |
| d | /d/ | “d” |
| f | /f/ | “f” |
| h | /h/ | “h” |
| j | / [symbol] / | “j” |
| k | /k/ | “k” |
| l | /l/ | “l” |
| m | /m/ | “m” |
| n | /n/ | “n” |
| ng | / [symbol] / | “ng” |
| p | /p/ | “p” |
| q | /kw/ | “kw” |
| r | / [symbol] / | “r” |
| s | /s/ | “s” |
| sh | /∫/ | “sh” |
| t | /t/ | “t” |
| th | /θ/ | “th” |
| v | /v/ | “v” |
| w | /w/ | “w” |
| z | /z/ | “z” |

Some letters, however, have more than one commonly used pronunciation. For example, in English, the letter “c” commonly represents both the /k/ and /s/ sounds, so it does not have a “standard” pronunciation. Further, in English, each vowel letter is commonly understood to have both a “short” and a “long” form (and sometimes can represent other sounds as well; for example, the letter “a” can represent at least three distinct vowel sounds, and the letters “i” and “y” can represent either vowel or consonant sounds) and thus do not have “standard” pronunciations. Table 2 sets forth English letters that have alternate pronunciations, along with the IPA and informal phonetic transcriptions of some of the sounds those letters represent.

TABLE 2
Alternate pronunciations of English letters

| English | | |
|---|---|---|
| letter or | IPA | Informal |
| cluster | transcription | transcription |
| a | /ae/ (short) | “a” (short) |
| | /eI/ (long) | “ey” (long) |
| | /α/ or /a/ | “ah” |
| c | /k/ | “k” |
| | /s/ | “s” |
| | /∫/ | “sh” |
| | /t∫/ | “ch” |
| | / [symbol] / | “zh” |
| e | /ε/ (short) | “eh” (short) |
| | /i/ (long) | “ee” (long) |
| g | /g/ | “g” |
| | / [symbol] / | “j” |
| i | /I/ (short) | “ih” (short) |
| | /aI/ (long) | “aye” (long) |
| | /j/ (consonant) | “y” (consonant) |
| o | / [symbol] / or / [symbol] / (short) | “aw” (short) |
| | / [symbol] / (long) | “oh” (long) |
| s | /z/ | “z” |
| | /∫/ | “sh” |
| | /t∫/ | “ch” |
| | / [symbol] / | “zh” |
| t | /∫/ | “sh” |
| | /t∫/ | “ch” |
| | / [symbol] / | “zh” |
| th | /ð/ | “th” |
| u | /Λ/ (short) | “uh” (short) |
| | /ju/ (long) | “yoo” (long) |
| x | /ks/ | “x” or “ks” |
| | /gs/ | “gz” |
| y | /i/ (long e) | “ee” (short) |
| | /aI/ (long i) | “aye” (long) |
| | /I/ (short i) | “ih” (short i) |
| | /j/ (consonant) | “y” (consonant) |

For example, the “t” in the word “tour” / [symbol] / is not annotated because it represents the sound /t/ that is commonly associated with that letter, whereas the “t” in the word “function” / [symbol] / is annotated to indicate that it represents the alternate sound /∫/. Finally, some letter clusters occasionally represent sounds which are not set forth in Tables 1 and 2, but which are described below.

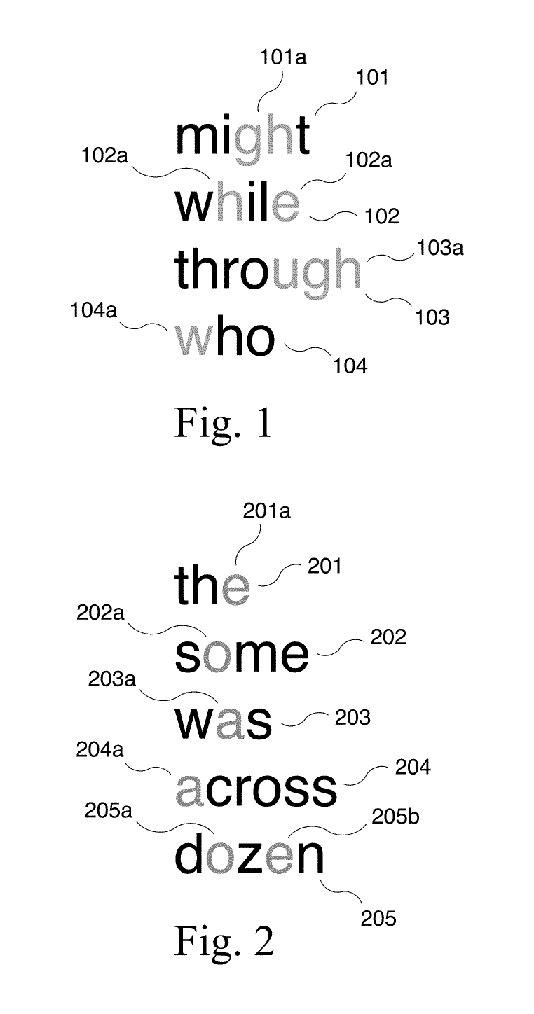

FIG. 1 shows how silent letters are printed or displayed in an embodiment of the present invention. In one or more embodiments, silent letters are identified by printing or displaying them in a light grey color on a white or paper-colored background. The reduced contrast of light grey letters causes them to appear less prominent, thereby indicating to the reader that those letters should not be pronounced. For example, the letters “gh” 101a in the word “might” / [symbol] / 101 appear in light grey because both those letters are silent. Similarly, both “h” 102a and “e” 102b in “while” / [symbol] / 102, “ugh” 103a in “through” / [symbol] / 103, and “w” 104a in “who” /hu/ 104 appear in light grey because those letters are silent in those words.

FIG. 2 shows how vowel letters with the schwa / [symbol] / sound are printed or displayed in an embodiment of the present invention. In some contexts, vowel letters are pronounced as the schwa / [symbol] / sound (sometimes spelled phonetically by English speakers as “uh”) instead of the common or standard sound (set forth in Table 1) that those vowel letters represent. In English, the schwa sound is the most common vowel sound and is typically found in unstressed syllables. In one or more embodiments, vowel letters with the schwa sound are identified by printing or displaying those letters in a green color. For example, the “e” 201a in the word “the” / [symbol] / 201 appears in green because it is pronounced / [symbol] / in that context. Similarly, “o” 202a in “some” / [symbol] / 202, “a” 203a in “was” / [symbol] / 203, “a” 204a in “across” / [symbol] / 204, and both “o” 205a and “e” 205b in “dozen” / [symbol] / 205 appear in green because those letters are pronounced / [symbol] / in those words.

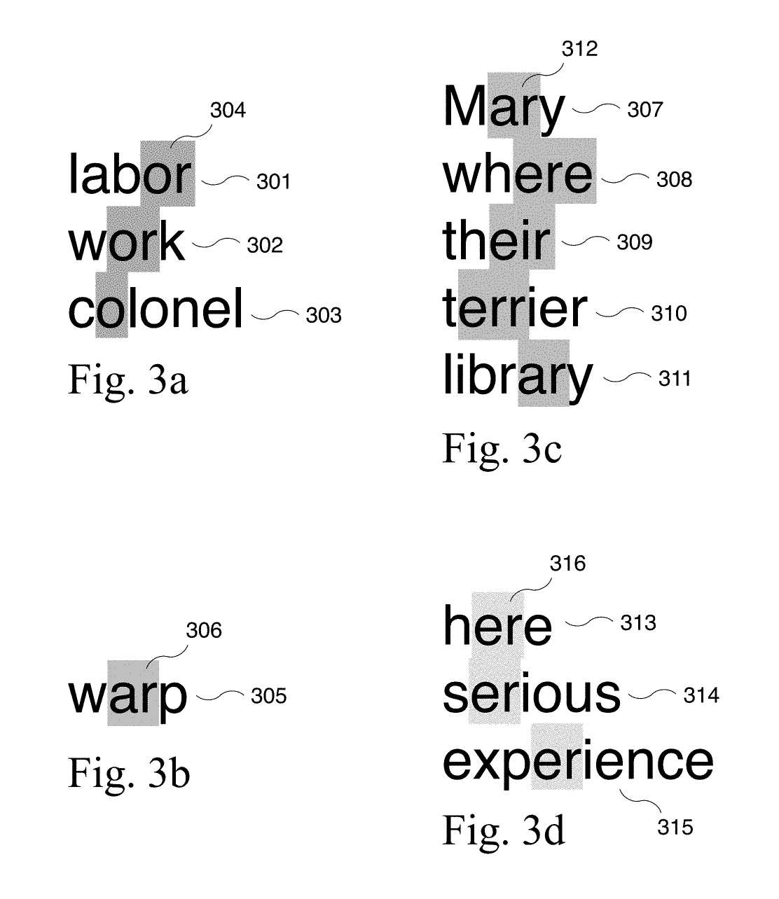

FIGS. 3a-3d show how rhotacized or “r-controlled” letter clusters are printed or displayed in an embodiment of the present invention. In one or more embodiments, rhotacized letter clusters are printed or displayed with a colored background when they are not pronounced the way they are spelled. The / [symbol] / or / [symbol] / sound, as in “labor” / [symbol] / 301, “work” / [symbol] / 302, and “colonel” / [symbol] / 303, is represented with a purple background 304, as shown in FIG. 3a. The / [symbol] / or / [symbol] / sound, as in “warp” / [symbol] / 305, is represented with an orange background 306, as shown in FIG. 3b. The / [symbol] / or / [symbol] / sound, as in “Mary” / [symbol] / 307, “where” / [symbol] / 308, “their” / [symbol] / 309, “terrier” / [symbol] / 310, and “library” / [symbol] / 311, is represented with a blue background 312, as shown in FIG. 3c. The / [symbol] / sound, as in “here” / [symbol] / 313, “serious” / [symbol] / 314, and “experience” / [symbol] / 315, is represented with a yellow background 316, as shown in FIG. 3d.

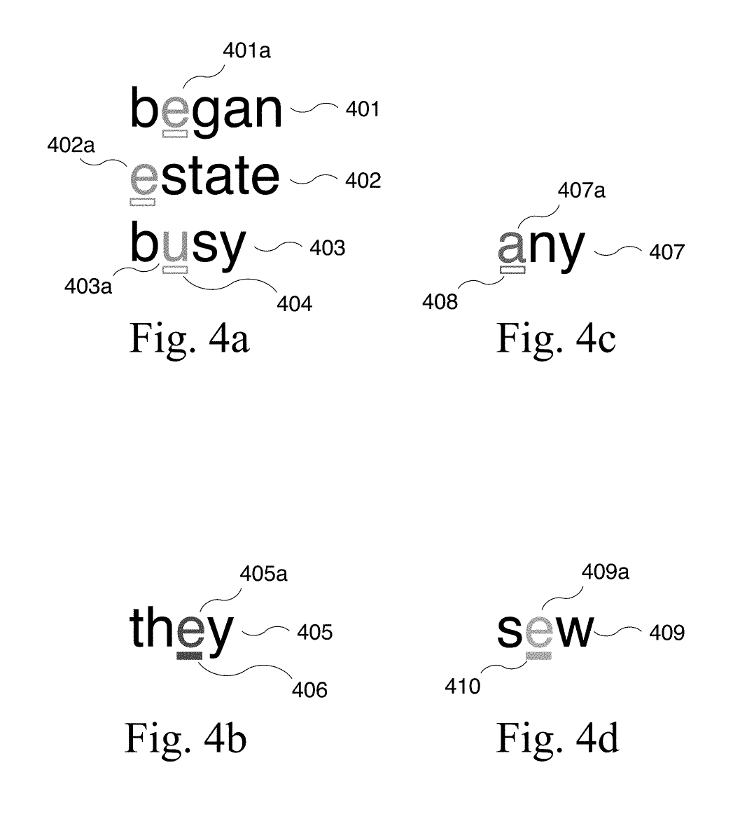

FIGS. 4a-4d show how vowel letters that sound like other vowels are printed or displayed in an embodiment of the present invention. In one or more embodiments, each vowel sound is represented by a particular color. Vowel letters that sound like other vowels are printed or displayed in the color that corresponds to the correct pronunciation. In one or more embodiments, a rectangular box of the same color appears under the vowel letter, with an outlined or empty box representing a “short” and a filled box representing a “long” sound.

In one or more embodiments, the color orange represents the /ι/ (“short i”) or / [symbol] / (“long i”) sounds. For example, the letter “e” 401a in “began” /bιgœn/ 401, the first letter “e” 402a in “estate” / [symbol] / 402, and the letter “u” 403a in “busy” / [symbol] / 403 appear in orange because those letters are pronounced /ι/ in those words. In addition, because those orange letters “e” 401a and 402a and “u” 403a represent the “short i” sound in those words 401, 402, and 403, an orange outlined box 404 appears under those letters.

In one or more embodiments, the color red represents the /æ/ (“short a”) or /eι/ (“long a”) sounds. For example, the letter “e” 405a in “they” / [symbol] / 405 appears in red because that letter is pronounced / [symbol] / in that word. In addition, because that red letter “e” 405a represents the “long a” sound in “they” 405, a red filled box 406 appears under that letter.

In one or more embodiments, the color blue represents the /ε/ (“short e”) or /i/ (“long e”) sounds. For example, the letter “a” 407a in “any” /εni/ 407 appears in blue because that letter is pronounced /ε/ in that word. In addition, because that blue letter “a” 407a represents the “short e” sound in “any” 407, a blue outlined box appears under that letter.

In one or more embodiments, the color purple represents the / [symbol] / (“short o”) or / [symbol] / (“long o”) sounds. For example, the letter “e” 409a in “sew” / [symbol] / 409 appears in purple because that letter is pronounced / [symbol] / in that word. In addition, because that purple letter “e” 409a represents the “long o” sound in “sew” 409, a purple filled box 410 appears under that letter.

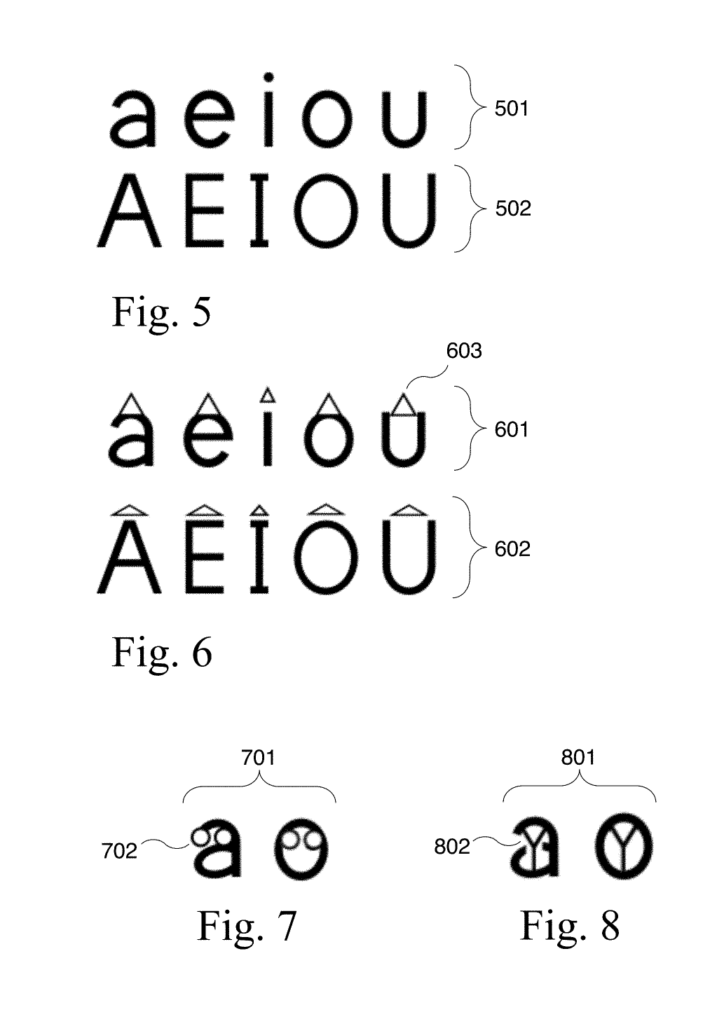

FIGS. 5-13 show how vowel letters are printed or displayed in an embodiment of the present invention. In one or more embodiments, vowel letters are annotated with markings to indicate which sound the vowel letter represents in a particular context. Short vowels are not annotated; therefore, the vowel sounds /æ/, /ε/, /ι/, / [symbol] /, and /Λ/ are printed or displayed without annotations as “a”, “e”, “i”, “o”, and “u” 501 (and their uppercase versions “A”, “E”, “I”, “O”, and “U” 502), respectively, as shown in FIG. 5. Long vowels are annotated with a triangular “hat” or caret-like symbol 603; therefore, the vowel sounds /eι/, /i/, /aι/, / [symbol] /, and /ju/ are printed or displayed as shown in FIG. 6; rendered in text, they appear approximately as “â”, “ê”, “î”, “ô”, and “û” 601 (and their uppercase versions “Â”, “Ê”, “Î”, “Ô”, and “Û” 602), respectively.

In some contexts, the letters “a” and “o” represent the vowel sound / [symbol] /, as in “dog” / [symbol] / or “paw” / [symbol] /. In one or more embodiments, the letters “a” and “o” 701 are printed or displayed as shown in FIG. 7 with two circles 702 side by side in the center upper portion of the letter to represent the / [symbol] / sound. In one or more embodiments, the appearance of the letters “a” and “o” 701 as shown in FIG. 7 serves as a memory aid by reminding the reader of the eyes on a dog's face, and therefore that the letters “a” and “o” 701 as shown in FIG. 7 represent the / [symbol] / sound in “dog”.

In some contexts, the letters “a” and “o” represent the vowel sound /a/, as in “ra” / [symbol] / or “cha” / [symbol] /. In one or more embodiments, the letters “a” and “o” 801 are printed or displayed as shown in FIG. 8 with a Y-shaped FIG. 802 in the center of the letter to represent the /a/ sound. In one or more embodiments, the appearance of the letters “a” and “o” 801 as shown in FIG. 8 serves as a memory aid by reminding the reader of a cheerleader with arms outstretched shouting “rah, rah”, and therefore that the letters “a” and “o” 801 as shown in FIG. 8 represent the /a/ sound in “rah”.

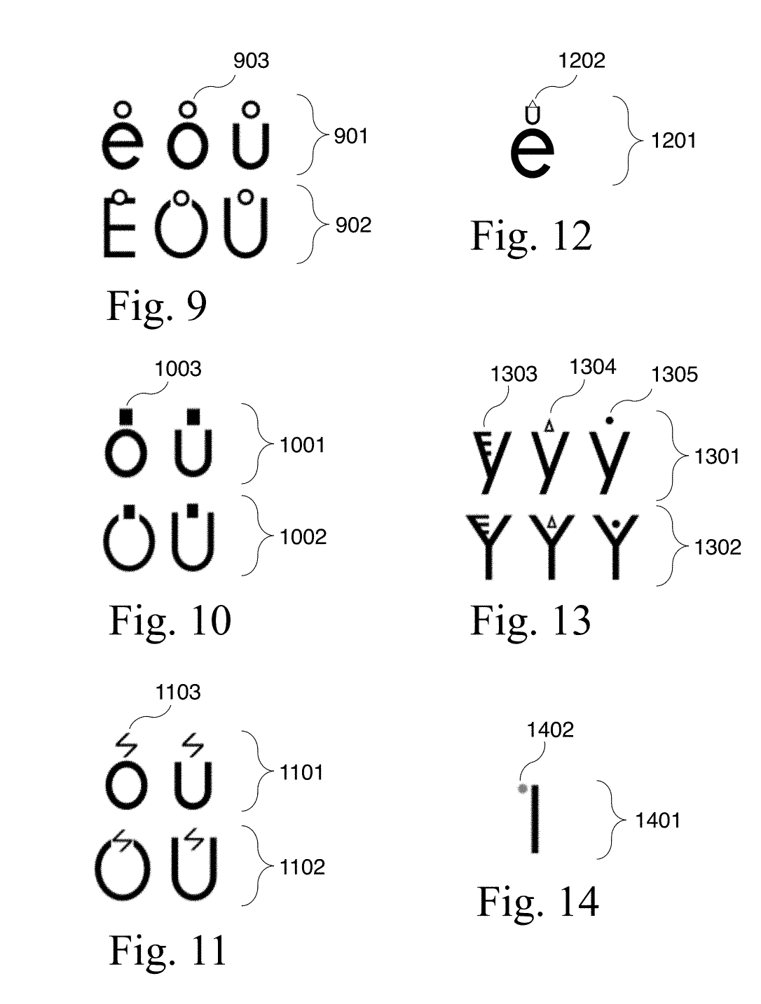

In some contexts, the letters “e”, “o”, and “u” represent the vowel sound /u:/, as in “snooze” /snu:z/, “cruise” / [symbol] /, or “hoop” /hu:p/. In one or more embodiments, the letters “e”, “o”, and “u” 901 (and their uppercase versions “E”, “O”, and “U” 902) are printed or displayed as shown in FIG. 9 with a circle or “hoop” 903 above the letter to represent the /u:/ sound. In one or more embodiments, the appearance of the letters “e”, “o”, and “u” 901 and 902 as shown in FIG. 9 serves as a memory aid by reminding the reader of a hoop, and therefore that the letters “e”, “o”, and “u” 901 and 902 as shown in FIG. 9 represent the /u:/ sound in “hoop”. In one or more embodiments, a circle or “hoop” 903 may appear above letters other than “e”, “o”, or “u” when those other letters represent the /u:/ sound.

In some contexts, the letters “o” and “u” represent the vowel sound / [symbol] /, as in “book” / [symbol] / or “push” / [symbol] /. In one or more embodiments, the letters “o” and “u” 1001 (and their uppercase versions “O” and “U” 1002) are printed or displayed as shown in FIG. 10 with a book-shaped symbol 1003 above the letter to represent the / [symbol] / sound. In one or more embodiments, the appearance of the letters “o” and “u” 1001 and 1002 as shown in FIG. 10 serves as a memory aid by reminding the reader of a book, and therefore that the letters “o” and “u” 1001 and 1002 as shown in FIG. 10 represent the / [symbol] / sound in “book”. In one or more embodiments, a book-shaped symbol 1003 may appear above letters other than “o” or “u” when those other letters represent the / [symbol] / sound.

In some contexts, the letters “o” and “u” represent the vowel sound / [symbol] /, as in “power” / [symbol] /, “mouse” / [symbol] /, or “ouch” / [symbol] /. In one or more embodiments, the letters “o” and “u” 1101 (and their uppercase versions “0” and “U” 1102) are printed or displayed as shown in FIG. 11 with a zig-zag or “electric spark” symbol 1103 above the letter to represent the / [symbol] / sound. In one or more embodiments, the appearance of the letters “o” and “u” 1101 and 1102 as shown in FIG. 11 serves as a memory aid by reminding the reader of an electric spark that might cause the reader to say “ouch”, and therefore that the letters “o” and “u” 1101 and 1102 as shown in FIG. 11 represent the / [symbol] / sound in “ouch”. In one or more embodiments, a zig-zag or “electric spark” symbol 1103 may appear above letters other than “o” or “u” when those other letters represent the / [symbol] / sound.

In some contexts, the letter “e” represents the vowel sound /ju/, as in “fewest” / [symbol] /. In one or more embodiments, the letter “e” 1201 is printed or displayed as shown in FIG. 12 with a letter “u” with a triangular “hat” or caret-like symbol 1202 above the letter “e” to represent the /ju/ sound. In one or more embodiments, the appearance of the letter “e” 1201 as shown in FIG. 12 serves as a memory aid by reminding the reader of the long “u” sound represented by the “u” with a triangular “hat” shown in FIG. 6, and therefore that the letter “e” 1201 as shown in FIG. 12 represents the /ju/ sound. In one or more embodiments, a letter “u” with a triangular “hat” or caret-like symbol 1202 may appear above letters other than “e” when those other letters represent the /ju/ sound.

The letter “y” can represent three different vowel sounds: /i/, as in “sherry” / [symbol] /; / [symbol] /, as in “my” / [symbol] /; and /ι/, as in “symbol” / [symbol] /. In one or more embodiments, the letter “y” 1301 (and its uppercase version “Y” 1302) is printed or displayed as shown in FIG. 13. Three horizontal lines 1303 extend rightward from the left “arm” of the “y” to represent the /i/ sound. In one or more embodiments, the appearance of the letter “y” 1301 and 1302 with three horizontal lines 1303 as shown in FIG. 13 serves as a memory aid by reminding the reader of the horizontal lines of capital letter “E”, and therefore that it represents the /i/ “long e” sound. A triangular “hat” or caret-like symbol 1304 (similar to the “long” vowel triangle symbol 603 discussed above) appears above the “y” 1301 and 1302 to represent the / [symbol] / sound. In one or more embodiments, the appearance of the letter “y” 1301 and 1302 with a triangular “hat” 1304 as shown in FIG. 13 serves as a memory aid by reminding the reader of the “long” form of the letter “i”, and therefore that it represents the / [symbol] / “long i” sound. A filled circle or dot 1305 appears above the “y” 1301 and 1302 to represent the /ι/ sound. In one or more embodiments, the appearance of the letter “y” 1301 and 1302 with a filled circle or dot 1305 as shown in FIG. 13 serves as a memory aid by reminding the reader of the “short” form of the letter “i”, and therefore that it represents the /ι/ “short i” sound.

In some contexts, schwa / [symbol] / sound is pronounced before the letter “l” even though no vowel letter appears before the “l”, as in “trouble” / [symbol] / or “castle” / [symbol] /. In one or more embodiments, the letter “l” 1401 is printed or displayed as shown in FIG. 14. A green dot 1402 appears to the upper left of the “l” to represent the / [symbol] / sound. In one or more embodiments, the appearance of the letter “l” 1401 with green dot 1402 as shown in FIG. 14 serves as a memory aid by reminding the reader of the green color associated with the schwa / [symbol] / sound. In one or more embodiments, a green dot 1402 may appear to the upper left of letters other than “l” when a schwa / [symbol] / sound is pronounced before those other letters. For example, in “aspire” / [symbol] / or / [symbol] /, a schwa / [symbol] / sound is pronounced before the / [symbol] /, so a green dot 1402 would appear to the upper left of the “r” in “aspire” to represent the / [symbol] / or / [symbol] / sound.

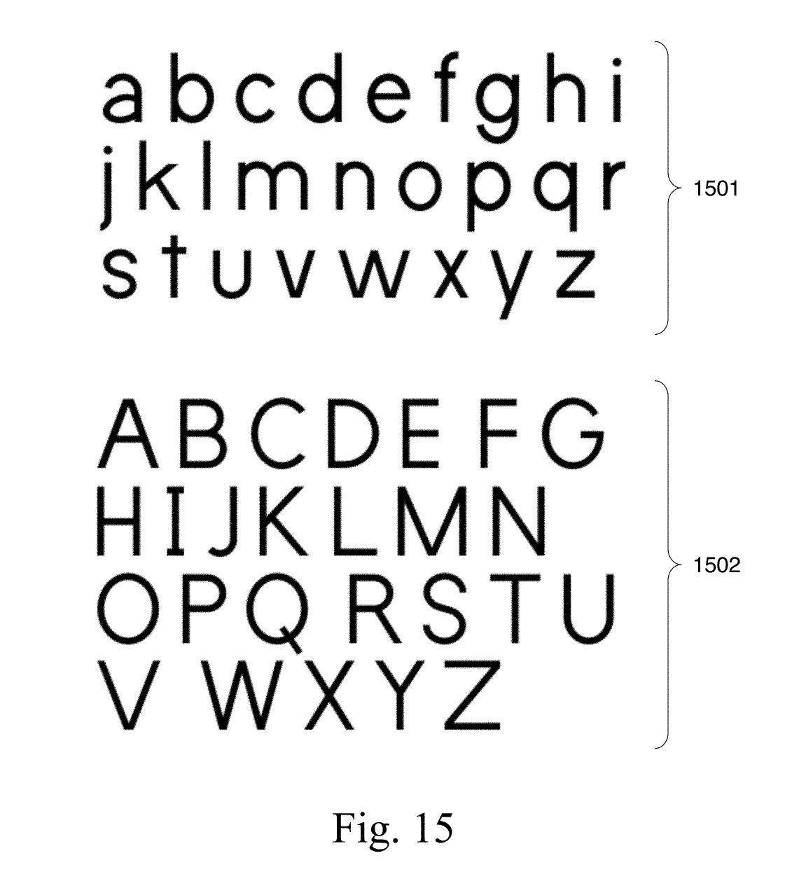

FIGS. 15-26 show how consonant letters or letter clusters are printed or displayed in an embodiment of the present invention. In one or more embodiments, consonant letters or letter clusters are annotated with markings to indicate which sound the consonant letter or letter cluster represents in a particular context. Consonant letters or letter clusters are not annotated when they are pronounced in the common or standard way set forth in Table 1; therefore, the consonant sounds /b /, /d /, /f/, /g/, /h /, / [symbol] /, /k/, /l/, /m /, /n /, /p /, /kw/, /s/, /t/, /v/, /w/, /ks/, /j/, and /z/are printed or displayed without annotations as the letters “b”, “c”, “d”, “f”, “g”, “h”, “j”, “k”, “l”, “m”, “n”, “p”, “q”, “r”, “s”, “t”, “v”, “w”, “x”, “y”, and “z” 1501 (and their uppercase versions “W”, “X”, “Y”, and “Z” 1502), respectively, as shown in FIG. 15. Similarly, the consonant sounds / [symbol] /, /∫/, and /θ/ or / [symbol] / are printed or displayed without annotations as the letter clusters “ch”, “sh”, and “th”.

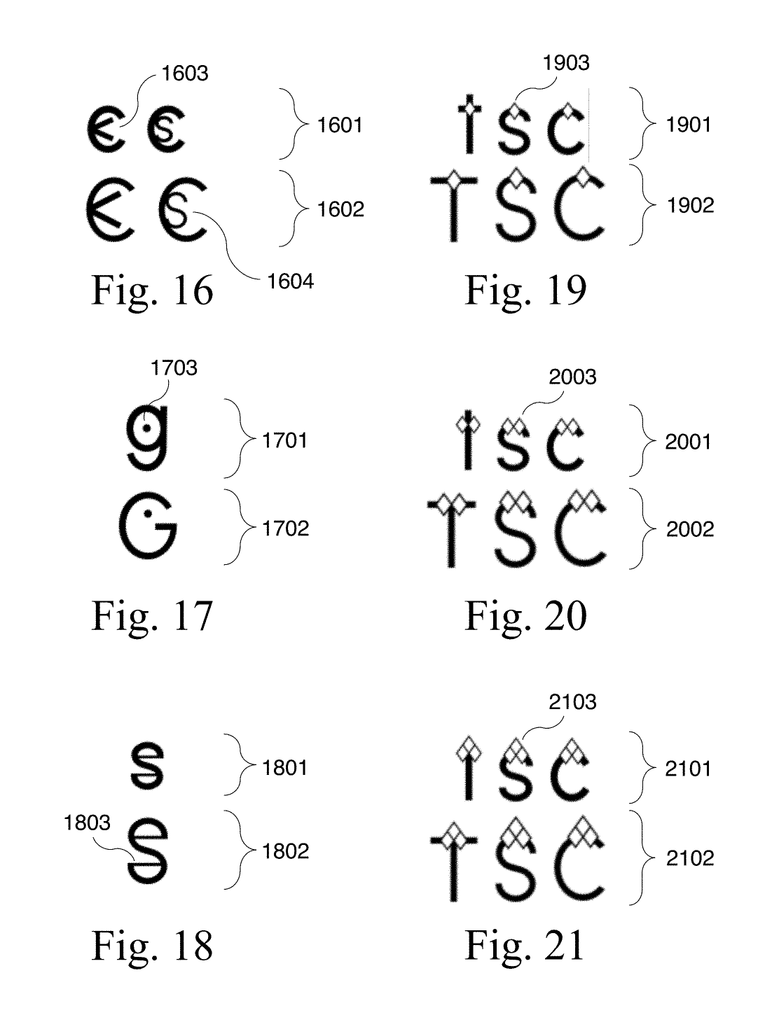

The letter “c” has two commonly used pronunciations: /k/, as in “car” / [symbol] /; and /s/, as in “cyan” / [symbol] /. In one or more embodiments, the letter “c” 1601 (and its uppercase version “C” 1602) is printed or displayed as shown in FIG. 16. Two lines 1603 extend rightward, one diagonally upward and one diagonally downward, from the left of the “c” to represent the /k/ sound. In one or more embodiments, the appearance of the letter “c” 1601 and 1602 with two diagonal lines 1603 as shown in FIG. 16 serves as a memory aid by reminding the reader of the letter “k”, and therefore that it represents the /k/ sound. A small “s” FIG. 1604 appears inside the “c” to represent the /s/ sound. In one or more embodiments, the appearance of the letter “c” 1601 and 1602 with small “s” FIG. 1604 as shown in FIG. 16 serves as a memory aid by reminding the reader of the letter “s”, and therefore that it represents the /s/ sound.

The letter “g” has two commonly used pronunciations: /g/, as in “go” / [symbol] /; and / [symbol] /, as in “gel” / [symbol] /. In one or more embodiments, the letter “g” is printed or displayed without annotations as shown in FIG. 15 when it represents the /g/ sound. In one or more embodiments, the letter “g” 1701 (and its uppercase version “G” 1702) is printed or displayed as shown in FIG. 17. A dot 1703 appears inside the upper loop of the “g” to represent the / [symbol] / sound. In one or more embodiments, the appearance of the letter “g” 1701 and 1702 with dot 1703 as shown in FIG. 17 serves as a memory aid by reminding the reader of the letter “j”, and therefore that it represents the / [symbol] / sound.

The letter “s” has two commonly used pronunciations: /s/, as in “star” / [symbol] /; and /z/, as in “propose” / [symbol] /. In one or more embodiments, the letter “s” is printed or displayed without annotations as shown in FIG. 15 when it represents the /s/ sound. In one or more embodiments, the letter “s” 1801 (and its uppercase version “S” 1802) is printed or displayed as shown in FIG. 18. Two lines 1803 extend horizontally across the upper and lower portions of the “s” to represent the /z/ sound. In one or more embodiments, the appearance of the letter “s” 1801 and 1802 with two horizontal lines 1803 as shown in FIG. 18 serves as a memory aid by reminding the reader of the letter “z”, and therefore that it represents the /z/ sound.

In addition to their standard or common pronunciations, the letters “t”, “s”, and “c” all can represent any of the three sounds /∫/, as in “function” / [symbol] /; / [symbol] /, as in “pasture” / [symbol] /; or / [symbol] /, as in “artesian” / [symbol] /. In one or more embodiments, the letters “t”, “s”, and “c” 1901 (and their uppercase versions “T”, “S”, and “C” 1902) are printed or displayed as shown in FIG. 19. A single diamond shape 1903 appears at the top of the letter to represent the /∫/ sound. In one or more embodiments, the letters “t”, “s”, and “c” 2001 (and their uppercase versions “T”, “S”, and “C” 2002) are printed or displayed as shown in FIG. 20. A double diamond shape 2003 appears at the top of the letter to represent the / [symbol] / sound. In one or more embodiments, the letters “t”, “s”, and “c” 2101 (and their uppercase versions “T”, “S”, and “C” 2102) are printed or displayed as shown in FIG. 21. A triple diamond shape 2103 appears at the top of the letter to represent the / [symbol] / sound. In one or more embodiments, a single diamond shape 1903, double diamond shape 2003, or triple diamond shape 2103 may appear above letters other than “t”, “s”, or “c” when those other letters represent the /∫/, / [symbol] /, or / [symbol] / sounds, respectively.

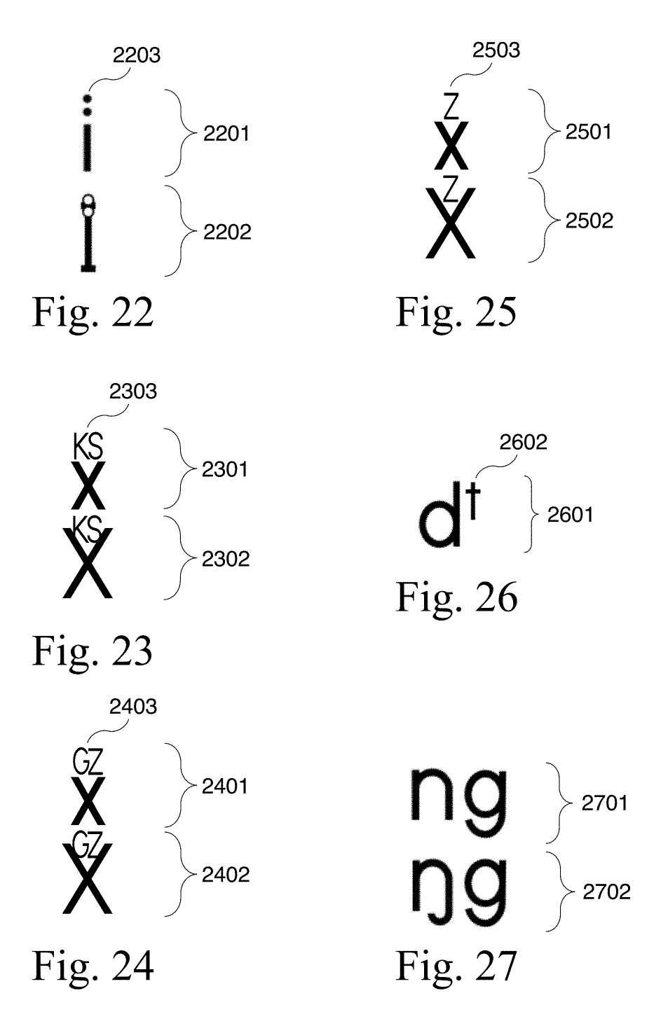

In addition to representing vowel sounds, the letter “i” sometimes represents the consonant sound /j/, as in “companion” / [symbol] / or “Spaniard” / [symbol] /. In one or more embodiments, the letter “i” 2201 (and its uppercase version “I” 2202) is printed or displayed as shown in FIG. 22. Two vertically stacked circles or dots 2203 appear above the “i” 2201 and 2202 to represent the /j/ sound.

The letter “x” has three commonly used pronunciations: /ks/, as in “exposure” / [symbol] /; /gz/, as in “examine” / [symbol] /; and /z/, as in “xylophone” / [symbol] /. In one or more embodiments, the letter “x” 2301 (and its uppercase version “X” 2302) is printed or displayed as shown in FIG. 23. The elongated capital letters “KS” 2303 appear above the “x” to represent the /ks/ sound. In one or more embodiments, the appearance of the letter “x” 2301 and 2302 with elongated capital letters “KS” 2303 as shown in FIG. 23 serves as a memory aid by reminding the reader that it represents the /ks/ sound. In one or more embodiments, the letter “x” 2401 (and its uppercase version “X” 2402) is printed or displayed as shown in FIG. 24. The elongated capital letters “GZ” 2403 appear above the “x” to represent the /gz/ sound. In one or more embodiments, the appearance of the letter “x” 2401 and 2402 with elongated capital letters “GZ” 2403 as shown in FIG. 24 serves as a memory aid by reminding the reader that it represents the /gz/ sound. In one or more embodiments, the letter “x” 2501 (and its uppercase version “X” 2502) is printed or displayed as shown in FIG. 25. The elongated capital letter “Z” 2503 appears above the “x” to represent the /z/ sound. In one or more embodiments, the appearance of the letter “x” 2501 and 2502 with elongated capital letter “Z” 2503 as shown in FIG. 25 serves as a memory aid by reminding the reader that it represents the /z/ sound.

In some contexts, the letter “d” represents the voiceless /t/ sound at the end of a word, as in “jumped” / [symbol] /. In one or more embodiments, the letter “d” 2601 is printed or displayed as shown in FIG. 26. A superscript letter “t” 2602 appears to the upper right of the “d” to represent the /t/ sound. In one or more embodiments, the appearance of the letter “d” 2601 with superscript letter “t” 2602 as shown in FIG. 26 serves as a memory aid by reminding the reader that it represents the /t/ sound.

The letter cluster “ng” has two commonly used pronunciations: / [symbol] /, as in “ring” / [symbol] /; and / [symbol] /, as in “England” / [symbol] /. In one or more embodiments, the letter cluster “ng” 2701 is printed or displayed without annotations as shown in FIG. 27 when it represents the / [symbol] / sound. In one or more embodiments, the letter cluster “ng” 2702 is printed or displayed as shown in FIG. 27 when it represents the / [symbol] / sound. A hook extends down and to the left from the right “leg” of the “n”. Note that the lowercase version of the “n” with a hook is similar to the IPA symbol / [symbol] /.

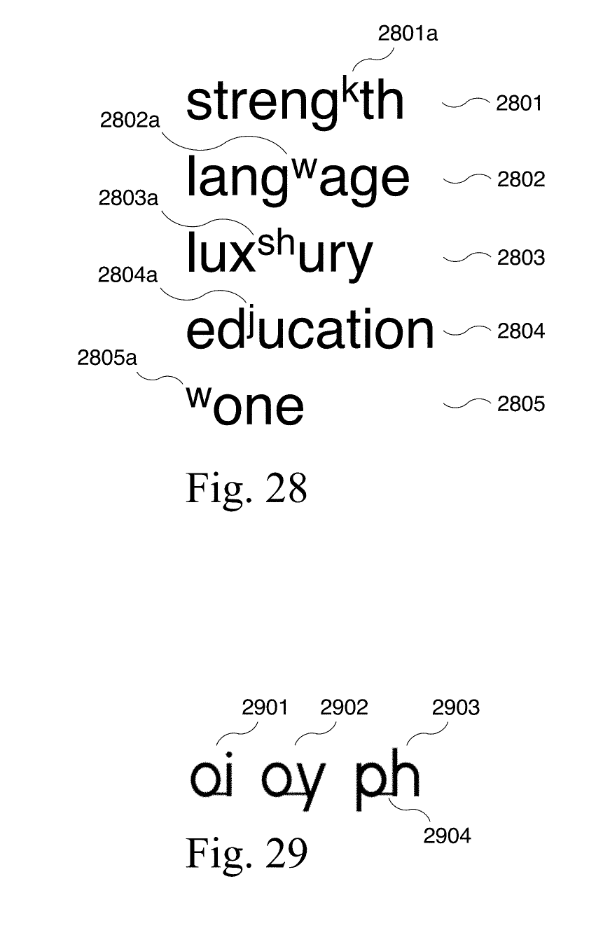

Sometimes a word has extra sounds that are not spelled out by the letters, as in “education” / [symbol] /, which has a / [symbol] / sound that does not appear in the spelling of the word. In one or more embodiments, the missing letters or sounds are printed or displayed in superscript as shown in FIG. 28. A superscript letter “k” 2801a appears between the “g” and “t” of “strength” / [symbol] / 2801 to indicate the “missing” /k/ sound. A superscript letter “w” 2802a appears between the “g” and “a” of “language” / [symbol] / 2802 to indicate the “missing” /w/ sound. A superscript letter cluster “sh” 2803a appears between the “x” and “u” of “luxury” / [symbol] / 2803 to indicate the “missing” /∫/ sound. A superscript letter “j” 2804a appears between the “d” and “u” of “education” / [symbol] / 2804 to indicate the “missing” / [symbol] / sound. A superscript letter “w” 2805a appears before the “o” of “one” /wΛn/ 2805 to indicate the initial “missing” /w/ sound.

In one or more embodiments, clusters of related letters, e.g., diphthong vowels, affricates, or other multiple letters that represent a single sound, are joined by a horizontal line 2904 at or near the baseline of the letters as shown in FIG. 29. For example, the letters “oi” 2901 represent the / [symbol] / diphthong, so a horizontal line 2904 joins the letters “o” and “i”. The letters “oy” 2902 also represent the / [symbol] / diphthong, so a horizontal line 2904 joins the letters “o” and “y”. Similarly, the letters “ph” 2903 represent the /f/ sound, so a horizontal line 2904 joins the letters “p” and “h”. Other letter clusters that may be joined by a horizontal line 2904 include, but are not limited to, “ch”, “sh”, and “th”.

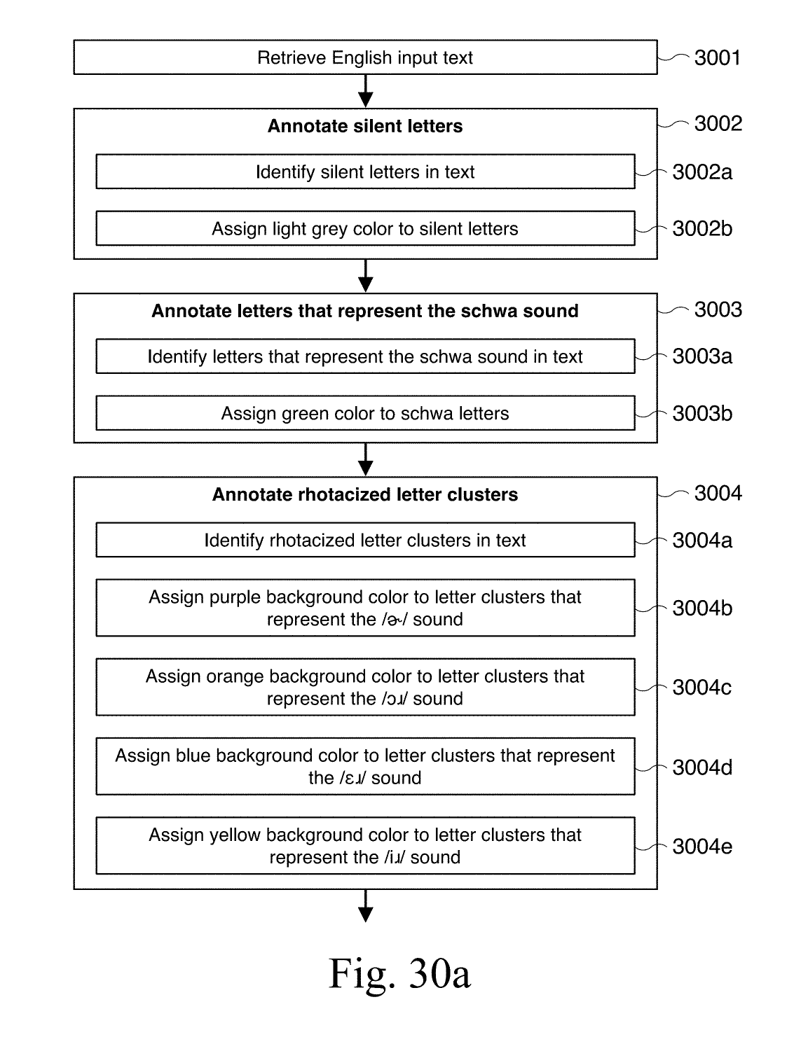

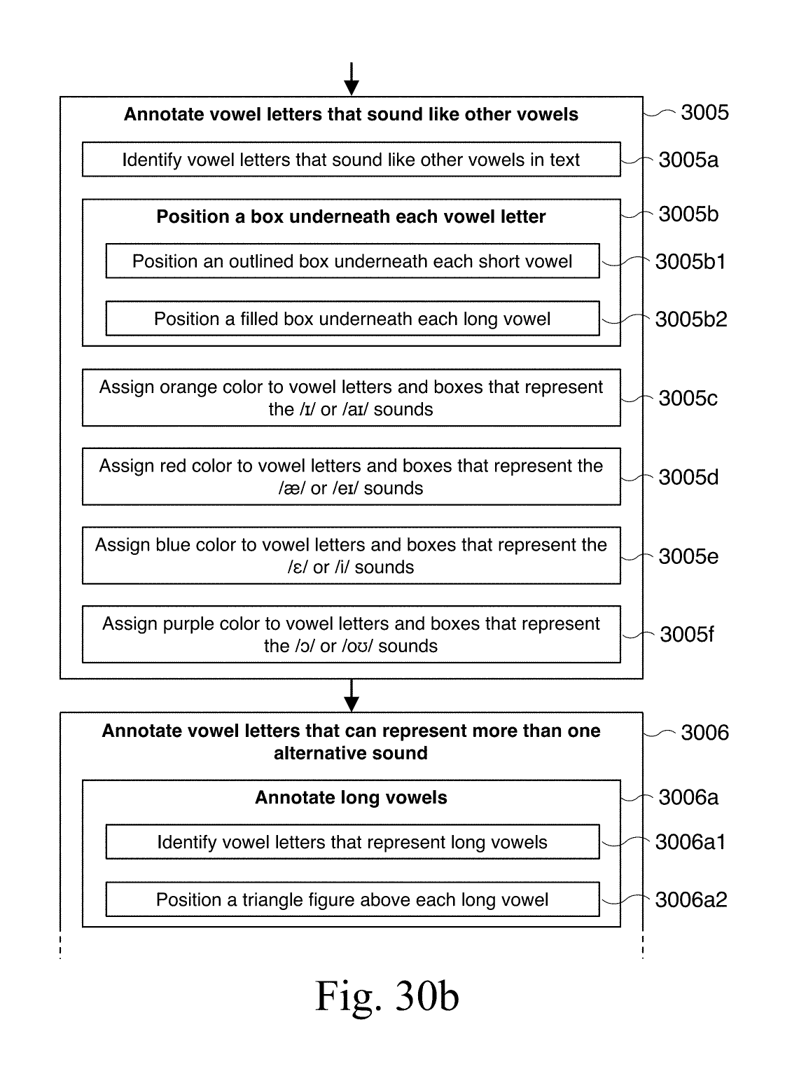

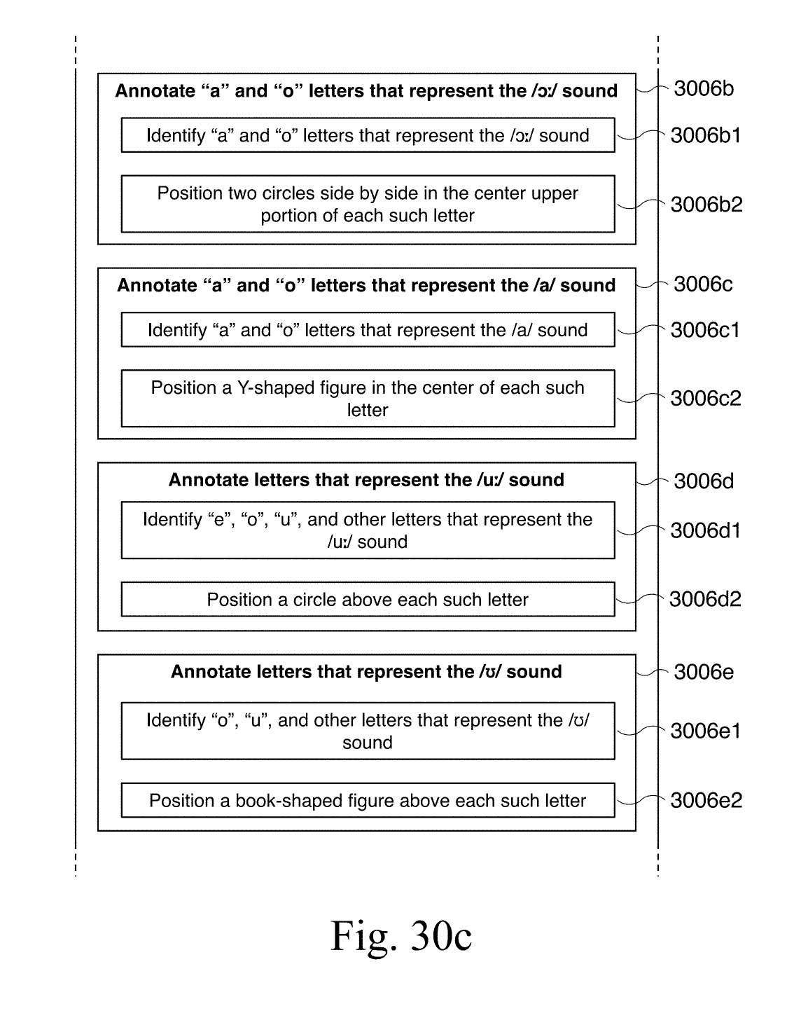

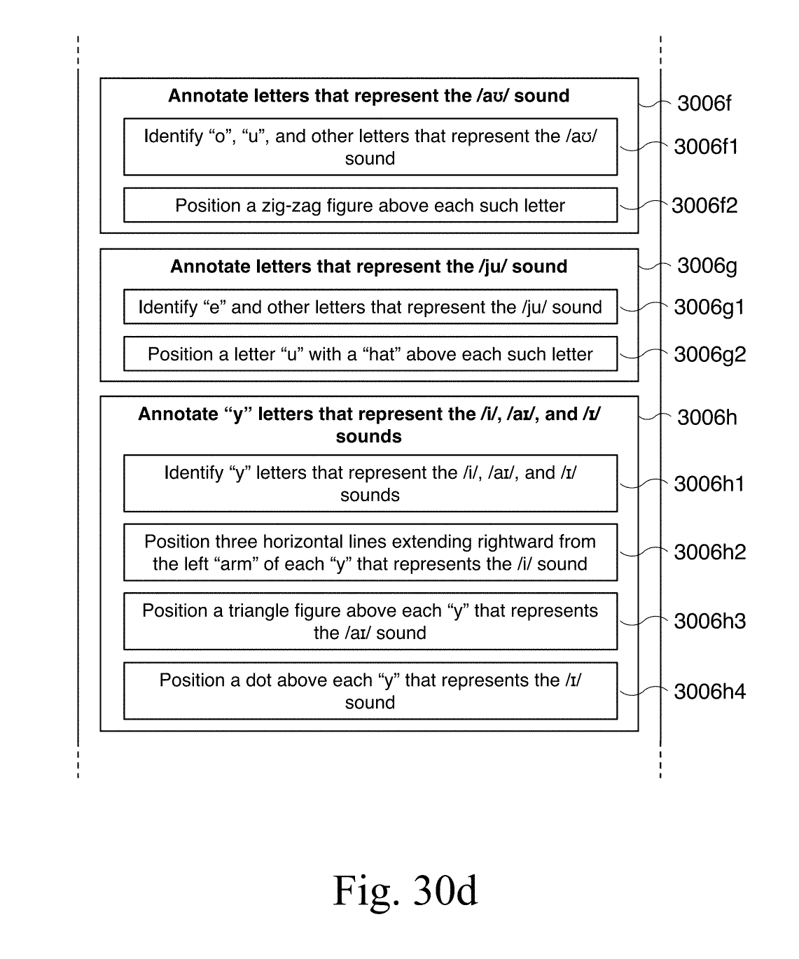

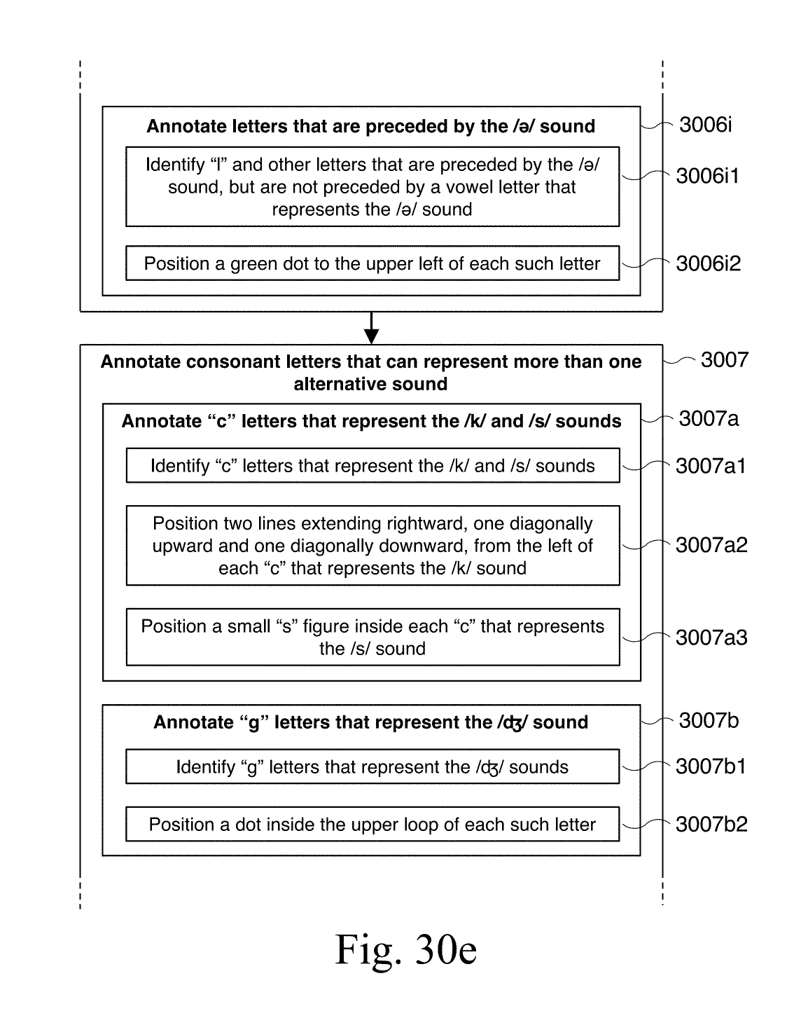

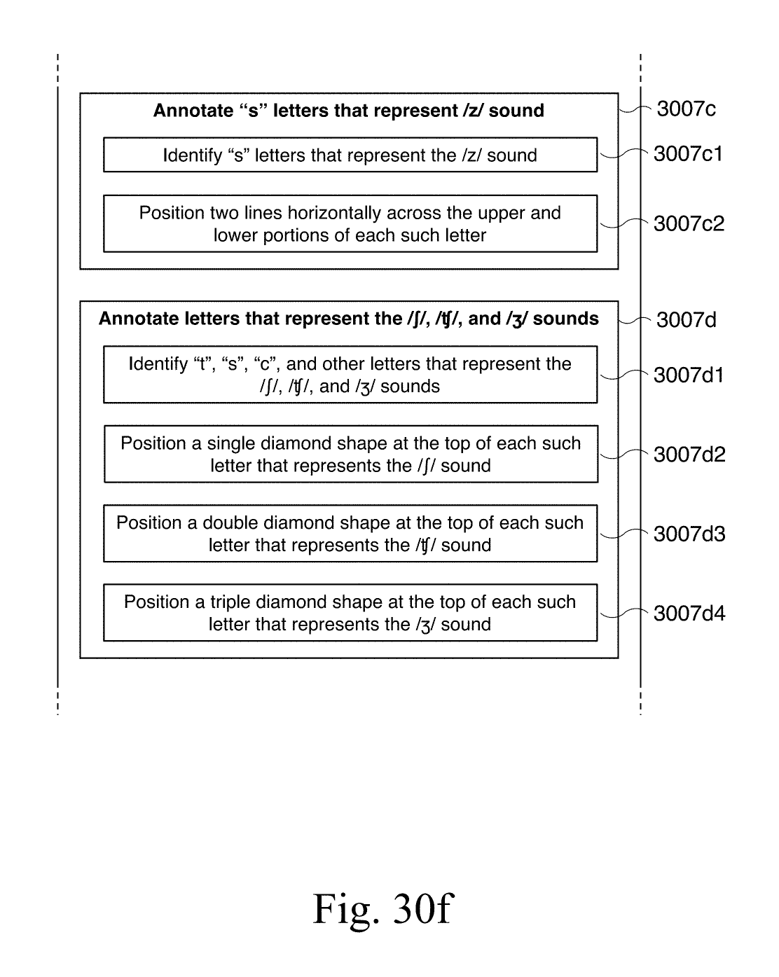

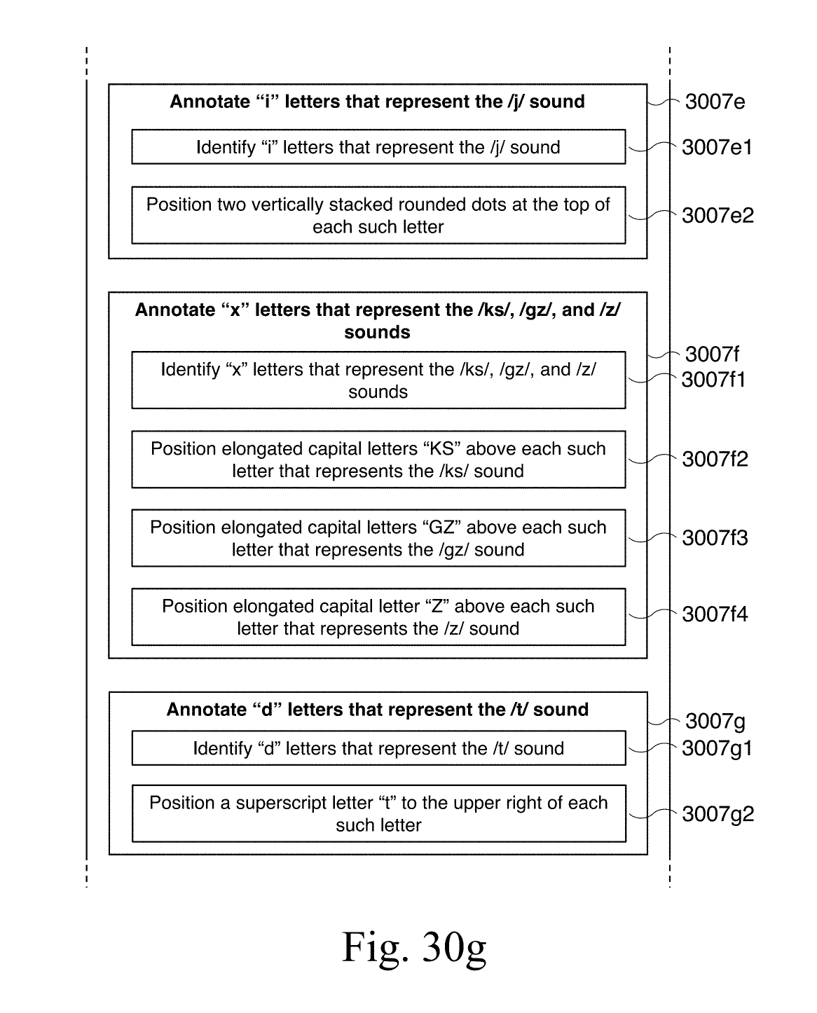

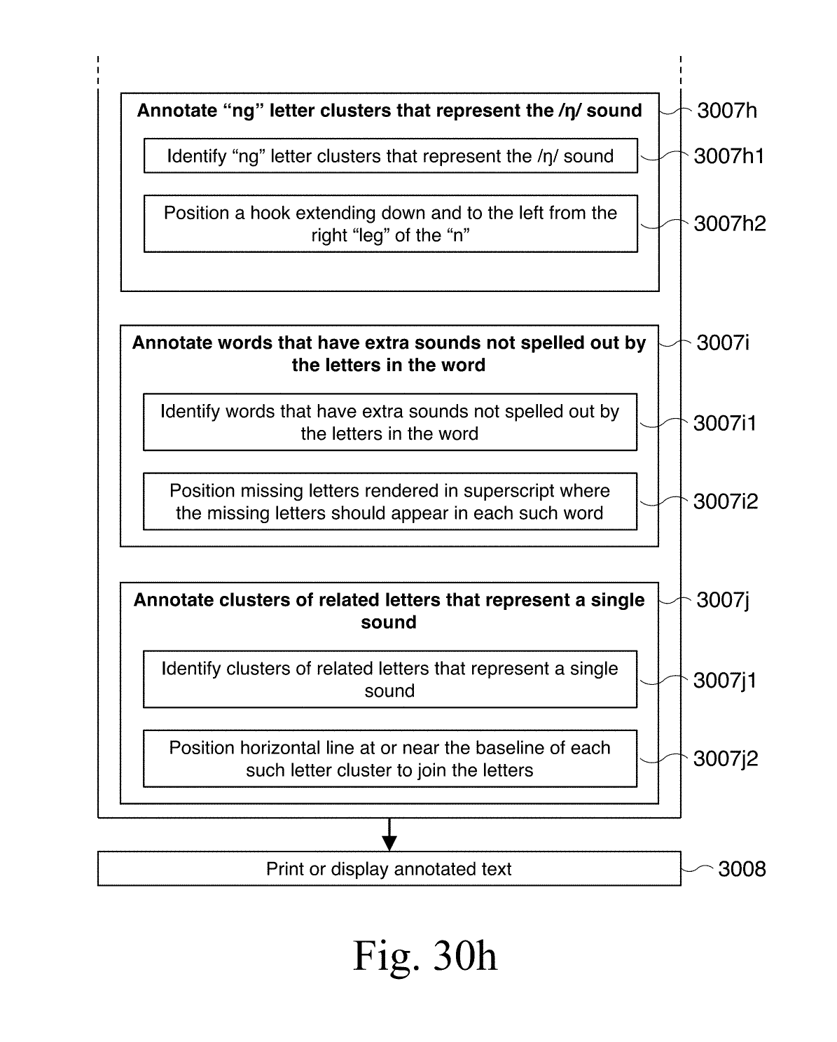

FIGS. 30a-30h are a flow chart illustrating a method for annotating written materials with phonetic information in accordance with an embodiment of the present invention. In the method illustrated in FIGS. 30a-30h, a class of letters may be “identified” in the text by, e.g., applying a set of rules that correctly identify those letters, or alternatively by comparing the written materials to a dictionary of already annotated words and matching the already annotated letters to the unannotated letters of the unannotated written materials. The method illustrated in FIGS. 30a-30h may be implemented in a computer system having a processor and memory, which is configured to transform an unannotated English text into an annotated text according to the steps of the method. Such an implementation is a preferred embodiment because the steps of the method may be executed quickly and accurately by a computer system. Furthermore, the use of a computer system having a processor and memory allows the use of a very large dictionary of annotated words loaded into the memory for use as a lookup table in the “identification” steps of the method.

The method begins in step 3001, where English input text is retrieved, e.g., from a computer-readable storage medium or other location suitable for storage of text. From step 3001, the method continues to step 3002. In step 3002, silent letters are annotated. Step 3002 may comprise steps 3002a and/or 3002b. In step 3002a, silent letters are identified in the text. In step 3002b, silent letters are assigned a light grey color.

From step 3002, the method continues to step 3003. In step 3003, letters that represent the schwa / [symbol] / sound are annotated. Step 3003 may comprise steps 3003a and/or 3003b. In step 3003a, letters that represent the schwa sound are identified in the text. In step 3003b, schwa letters are assigned a green color.

From step 3003, the method continues to step 3004. In step 3004, rhotacized letter clusters are annotated. Step 3004 may comprise steps 3004a, 3004b, 3004c, 3004d, and/or 3004e. In step 3004a, rhotacized letter clusters are identified in the text. In step 3004b, letter clusters that represent the / [symbol] / sound are assigned a purple background color. In step 3004c, letter clusters that represent the / [symbol] / sound are assigned an orange background color. In step 3004d, letter clusters that represent the / [symbol] / sound are assigned a blue background color. In step 3004e, letter clusters that represent the / [symbol] / sound are assigned a yellow background color.

From step 3004, the method continues to step 3005. In step 3005, vowel letters that sound like other vowels are annotated. Step 3005 may comprise steps 3005a, 3005b, 3005c, 3005d, 3005e, and/or 3005f. In step 3005a, vowel letters that sound like other vowels are identified in the text. In step 3005b, a box is positioned underneath each vowel letter that sounds like another vowel. Step 3005b may comprise steps 3005b1 and/or 3005b2. In step 3005b1, an outlined box is positioned underneath each short vowel. In step 3005b2, a filled box is positioned underneath each short vowel. In step 3005c, vowel letters and the boxes underneath that represent the /ι/ or / [symbol] / sound are assigned an orange color. In step 3005d, vowel letters and the boxes underneath that represent the /æ/ or / [symbol] / sound are assigned a red color. In step 3005e, vowel letters and the boxes underneath that represent the |ε| or /i/ sound are assigned a blue color. In step 3005f, vowel letters and the boxes underneath that represent the / [symbol] / or / [symbol] / sound are assigned a purple color.

From step 3005, the method continues to step 3006. In step 3006, vowel letters that can represent more than one alternative sound are annotated. Step 3006 may comprise steps 3006a, 3006b, 3006c, 3006d, 3006e, 3006f, 3006g, 3006h, and/or 3006i. In step 3006a, vowel letters that represent long vowels are annotated. Step 3006a may comprise steps 3006a1 and/or 3006a2. In step 3006a1, vowel letters that represent long vowels are identified in the text. In step 3006a2, a triangle figure is positioned above each long vowel.

In step 3006b, “a” and “o” letters that represent the / [symbol] / sound are annotated. Step 3006b may comprise steps 3006b1 and/or 3006b2. In step 3006b1, “a” and “o” letters that represent the / [symbol] / sound are identified in the text. In step 3006b2, two circles are positioned side by side in the center upper portion of each such letter.

In step 3006c, “a” and “o” letters that represent the /a/ sound are annotated. Step 3006c may comprise steps 3006c1 and/or 3006c2. In step 3006c1, “a” and “o” letters that represent the /a/ sound are identified in the text. In step 3006c2, a Y-shaped figure is positioned in the center of each such letter.

In step 3006d, “e”, “o”, “u”, and other letters that represent the /u:/ sound are annotated. Step 3006d may comprise steps 3006d1 and/or 3006d2. In step 3006d1, “e”, “o”, “u”, and other letters that represent the /u:/ sound are identified in the text. In step 3006d2, a circle is positioned above each such letter.

In step 3006e, “o”, “u”, and other letters that represent the / [symbol] / sound are annotated. Step 3006e may comprise steps 3006e1 and/or 3006e2. In step 3006e1, “o”, “u”, and other letters that represent the / [symbol] / sound are identified in the text. In step 3006e2, a book-shaped figure is positioned above each such letter.

In step 3006f, “o”, “u”, and other letters that represent the / [symbol] / sound are annotated. Step 3006f may comprise steps 3006f1 and/or 300612. In step 3006f1, “o”, “u”, and other letters that represent the / [symbol] / sound are identified in the text. In step 3006f2, a zig-zag figure is positioned above each such letter.

In step 3006g, “e” and other letters that represent the /ju/ sound are annotated. Step 3006g may comprise steps 3006g1 and/or 3006g2. In step 3006g1, “e” and other letters that represent the /ju/ sound are identified in the text. In step 3006g2, a letter “u” with a “hat” above is positioned above each such letter.

In step 3006h, “y” letters that represent the /i/, / [symbol] /, and /ι/ sounds are annotated. Step 3006h may comprise steps 3006h1, 3006h2, 3006h3, and/or 3006h4. In step 3006h1, “y” letters that represent the /i/, / [symbol] /, and /ι/ sounds are identified in the text. In step 3006h2, three horizontal lines are positioned extending rightward from the left “arm” of each “y” that represents the /i/ sound. In step 3006h3, a triangle figure is positioned above each “y” that represents the / [symbol] / sound. In step 3006h4, a dot is positioned above each “y” that represents the /ι/ sound.

In step 3006i, letters that are preceded by the / [symbol] / sound, but are not preceded by a vowel letter that represents the / [symbol] / sound, are annotated. Step 3006i may comprise steps 300611 and/or 300612. In step 300611, “l” and other letters that are preceded by the / [symbol] / sound, but are not preceded by a vowel letter that represents the / [symbol] / sound, are identified in the text. In step 300612, a green dot is positioned to the upper left of each such letter.

From step 3006, the method continues to step 3007. In step 3007, consonant letters that can represent more than one alternative sound are annotated. Step 3007 may comprise steps 3007a, 3007b, 3007c, 3007d, 3007e, 3007f, 3007g, 3007h, 3007i, and/or 3007j. In step 3007a, “c” letters that represent the /k/ and /s/ sounds are annotated. Step 3007a may comprise steps 3007a1, 3007a2, and/or 3007a3. In step 3007a1, “c” letters that represent the /k/ and /s/ sounds are identified in the text. In step 3007a2, two lines are positioned extending rightward, one diagonally upward and one diagonally downward, from the left of each “c” that represents the /k/ sound. In step 3007a3, a small “s” figure is positioned inside each “c” that represents the /s/ sound.

In step 3007b, “g” letters that represent the / [symbol] / sound are annotated. Step 3007b may comprise steps 3007b1 and/or 3007b2. In step 3007b1, “g” letters that represent the / [symbol] / sound are identified in the text. In step 3007b2, a dot is positioned inside the upper loop of each such letter.

In step 3007c, “s” letters that represent the /z/ sound are annotated. Step 3007c may comprise steps 3007c1 and/or 3007c2. In step 3007c1, “s” letters that represent the /z/ sound are identified in the text. In step 3007c2, two lines are positioned horizontally across the upper and lower portions of each such letter.

In step 3007d, “t”, “s”, “c”, and other letters that represent the /∫/, / [symbol] /, and / [symbol] / sounds are annotated. Step 3007d may comprise steps 3007d1, 3007d2, 3007d3, and/or 3007d4. In step 3007d1, “t”, “s”, “c”, and other letters that represent the /∫/, / [symbol] /, and / [symbol] / sounds are identified in the text. In step 3007d2, a single diamond shape is positioned at the top of each such letter that represents the /∫/ sound. In step 3007d3, a double diamond shape is positioned at the top of each such letter that represents the / [symbol] / sound. In step 3007d4, a triple diamond shape is positioned at the top of each such letter that represents the / [symbol] / sound.

In step 3007e, “i” letters that represent the /j/ sound are annotated. Step 3007e may comprise steps 3007e1 and/or 3007e2. In step 3007e1, “i” letters that represent the /j/ sound are identified in the text. In step 3007e2, two vertically stacked rounded dots are positioned at the top of each such letter.

In step 3007f, “x” letters that represent the /ks/, /gz/, and /z/ sounds are annotated. Step 3007f may comprise steps 3007f1, 3007f2, 30076, and/or 3007f4. In step 3007f1, “x” letters that represent the /ks/, /gz/, and /z/ sounds are identified in the text. In step 3007f2, elongated capital letters “KS” are positioned above each such letter that represents the /ks/ sound. In step 3007f3, elongated capital letters “GZ” are positioned above each such letter that represents the /gz/ sound. In step 3007f4, an elongated capital letter “Z” is positioned above each such letter that represents the /z/ sound.

In step 3007g, “d” letters that represent the /t/ sound are annotated. Step 3007g may comprise steps 3007g1 and/or 3007g2. In step 3007g1, “d” letters that represent the /t/ sound are identified in the text. In step 3007g2, a superscript letter “t” is positioned to the upper right of each such letter.

In step 3007h, “ng” letter clusters that represent the / [symbol] / sound are annotated. Step 3007h may comprise steps 3007h1 and/or 3007h2. In step 3007h1, “ng” letter clusters that represent / [symbol] / sound are identified in the text. In step 3007h2, a hook is positioned extending down and to the left from the right “leg” of the “n”.

In step 3007i, words that have extra sounds not spelled out by the letters in the word are annotated. Step 3007i may comprise steps 300711 and/or 300712. In step 300711, words that have extra sounds not spelled out by the letters in the word are identified in the text. In step 300712, missing letters are rendered in superscript and positioned where the missing letters should appear in each such word.

In step 3007j, clusters of related letters that represent a single sound are annotated. Step 3007j may comprise steps 3007j1 and/or 3007j2. In step 3007j1, clusters of related letters that represent a single sound are identified in the text. In step 3007j2, a horizontal line is positioned at or near the baseline of each such letter cluster to join the letters.

From step 3007, the method continues to step 3008. In step 3008, annotations are complete and the annotated text is printed or displayed.

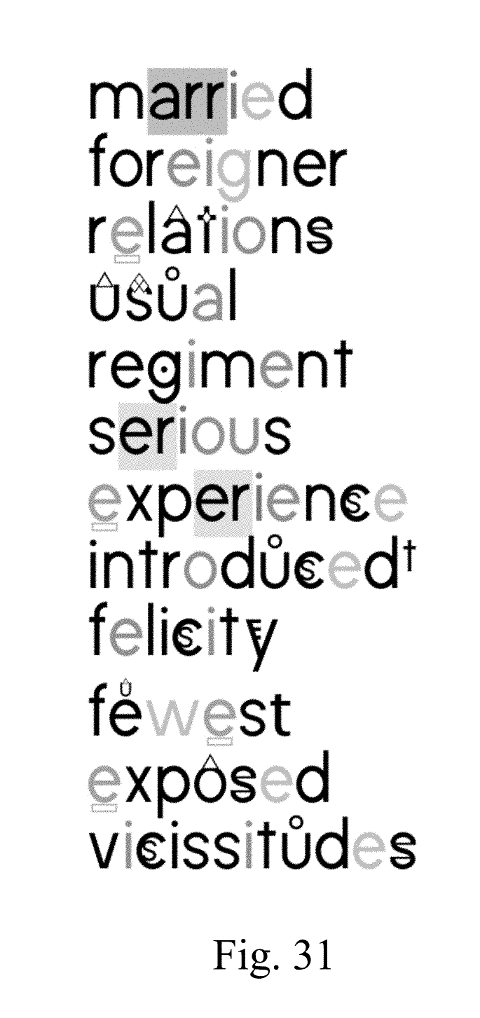

FIG. 31 shows several example words fully annotated using the method of an embodiment of the present invention. For example, FIG. 31 shows annotations for light grey “silent” letters, green schwa / [symbol] /vowels, short and long vowels, and “special” or alternate vowel and consonant sounds, among other annotations.

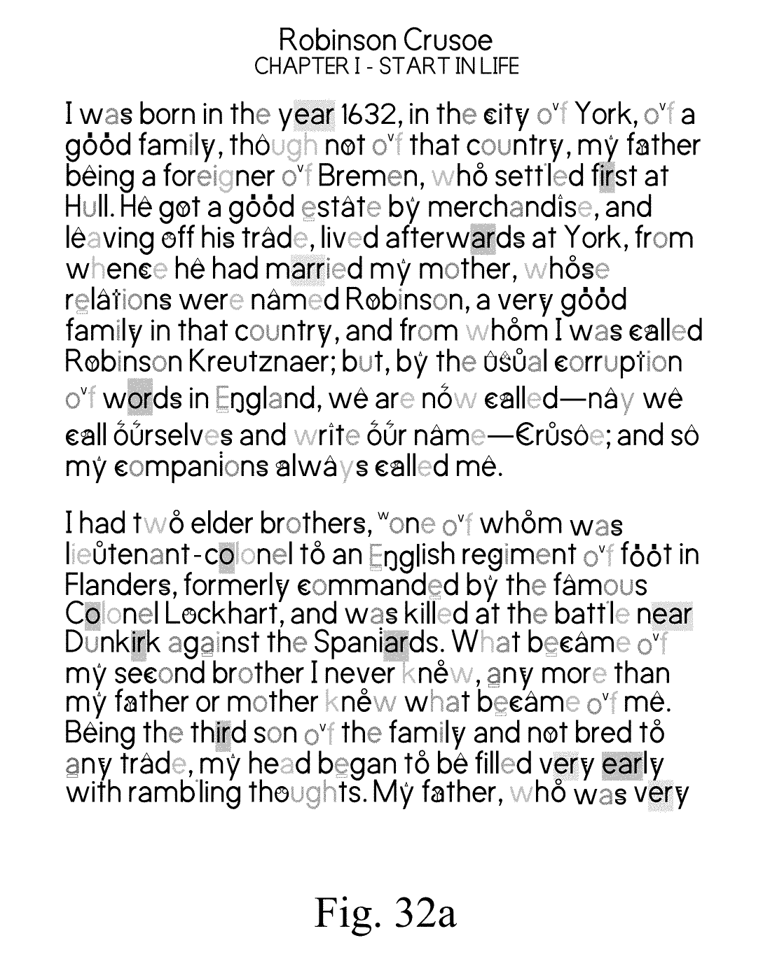

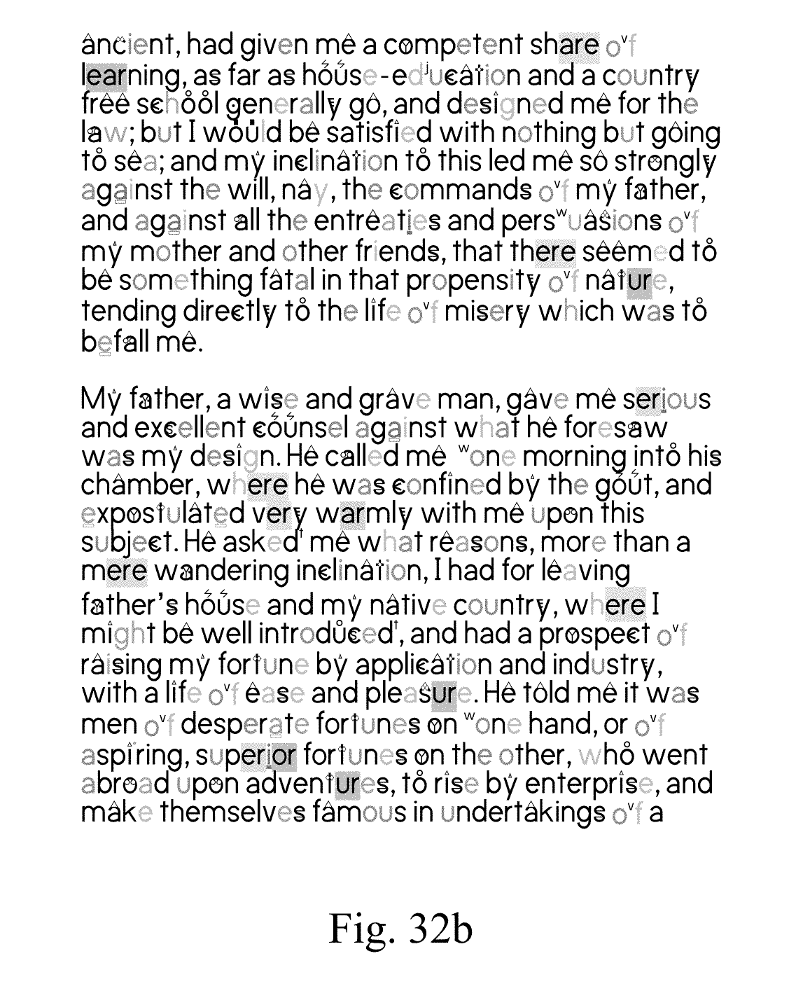

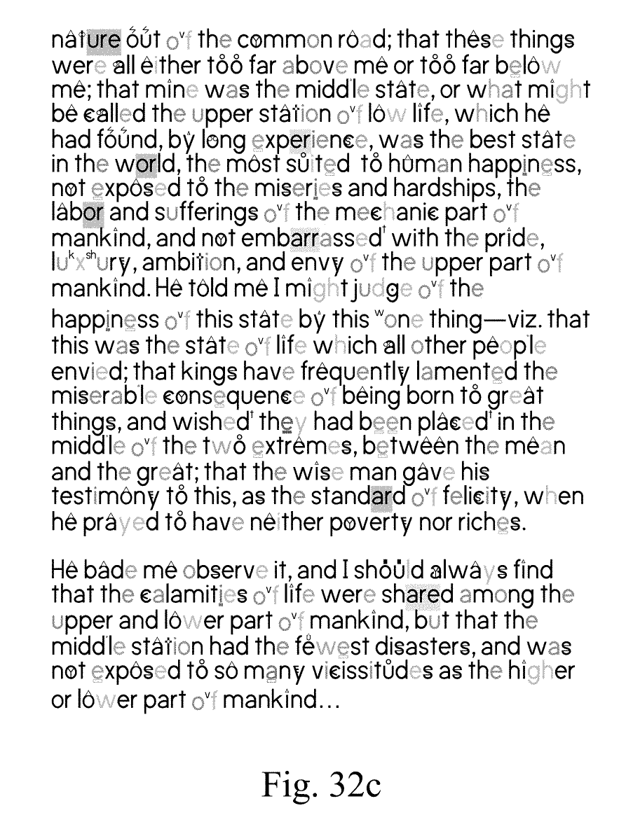

FIGS. 32a-32c are an excerpt from “Robinson Crusoe” fully annotated using the method of an embodiment of the present invention. For example, FIGS. 32a-32c show annotations for light grey “silent” letters, green schwa / [symbol] /vowels, short and long vowels, and “special” or alternate vowel and consonant sounds, among other annotations.

Thus, a system and method for annotating written materials with phonetic information to indicate the correct pronunciation of those written materials is described. Although the present invention has been described with respect to certain specific embodiments, it will be clear to those skilled in the art that the inventive features of the present invention are applicable to other embodiments as well, all of which are intended to fall within the scope of the present invention.

1. A method for annotating letters with phonetic information, said method comprising the steps of:
printing or displaying the letters that are silent in a first color;
printing or displaying the letters that represent the schwa sound in a second color, wherein said second color is different from the first color;
printing or displaying the letters that represent vowel sounds and do not represent the schwa sound in a first set of colors, wherein said first set of colors does not include the first color or the second color; and
printing or displaying the background of the letters that represent rhotacized vowel sounds in a second set of colors, wherein said second set of colors does not include the first color or the second color.

2. The method of claim 1 further comprising the steps of:
printing or displaying an outlined rectangular box below each letter that represents a short vowel sound, wherein the outline of said rectangular box is the same color as said letter that represents a short vowel sound; and
printing or displaying a filled rectangular box below each letter that represents a long vowel sound, wherein said filled rectangular box is the same color as said letter that represents a long vowel sound.

3. The method of claim 2 further comprising the steps of:
printing or displaying a triangular figure above each letter that represents a long vowel sound;
printing or displaying two circular figures side by side in the center upper portion of each letter that represents the / [symbol] / sound;
printing or displaying a “Y”-shaped figure in the center of each letter that represents the /a/ sound;
printing or displaying a circular figure above each letter that represents the /u:/ sound;
printing or displaying a square figure above each letter that represents the / [symbol] / sound;
printing or displaying a zig-zag shaped figure above each letter that represents the / [symbol] / sound;
printing or displaying a letter “u” and a triangular figure above said letter “u” above each letter that represents the /ju/ sound;
printing or displaying three horizontal lines in the center upper portion of each letter “y” that represents the /i/ sound;
printing or displaying a triangular figure above each letter “y” that represents the / [symbol] / sound; and
printing or displaying a dot above each letter “y” that represents the sound.

4. The method of claim 3 further comprising the steps of:
printing or displaying a dot in said second color to the upper left of each letter that is preceded by the / [symbol] / sound and is not preceded by a vowel letter that represents the / [symbol] / sound;
printing or displaying a “<”-shaped figure in the center of each letter “c” that represents the /k/ sound;
printing or displaying an “s”-shaped figure in the center of each letter “c” that represents the /s/ sound;
printing or displaying a dot in the upper loop of each letter “g” that represents the / [symbol] / sound;
printing or displaying a first line that extends horizontally across the upper portion and a second line that extends horizontally across the lower portion of each letter “s” that represents the /z/ sound;
printing or displaying a single diamond figure above each letter that represents the /∫/ sound;
printing or displaying a double diamond figure above each letter that represents the / [symbol] / sound;
printing or displaying a triple diamond figure above each letter that represents the / [symbol] / sound;
printing or displaying two vertically stacked dots above each letter “i” that represents the /j/ sound;
printing or displaying the letters “KS” above each letter “x” that represents the /ks/ sound;
printing or displaying the letters “GZ” above each letter “x” that represents the /gz/ sound;
printing or displaying the letter “Z” above each letter “x” that represents the /z/ sound;
printing or displaying the letter “t” to the upper right of each letter “d” that represents the /t/ sound; and
printing or displaying the letters “ [symbol] ” in place of each letter cluster “ng” that represents the / [symbol] / sound;

5. The method of claim 4 further comprising the steps of:
identifying a space between a first letter and a second letter of a word wherein one or more sounds are pronounced between said first letter and said second letter and wherein a set of one or more letters corresponding to said one or more sounds does not appear in the conventional spelling of said word; and
printing or displaying the set of one or more letters in superscript in said space between said first letter and said second letter.

6. The method of claim 5 further comprising the step of printing or displaying a horizontal line at the baseline of each letter cluster that represents a single sound.

7. A printed page comprising:
letters that are silent printed in a first color;
letters that represent the schwa sound printed in a second color, wherein said second color is different from the first color;
letters that represent vowel sounds and do not represent the schwa sound printed in a first set of colors, wherein said first set of colors does not include the first color or the second color; and
letters that represent rhotacized vowel sounds printed in a second set of colors, wherein said second set of colors does not include the first color or the second color.

8. The printed page of claim 7 further comprising:
an outlined rectangular box printed below each letter that represents a short vowel sound, wherein the outline of said rectangular box is the same color as said letter that represents a short vowel sound; and
a filled rectangular box printed below each letter that represents a long vowel sound, wherein said filled rectangular box is the same color as said letter that represents a long vowel sound.

9. The printed page of claim 8 further comprising:
a triangular figure printed above each letter that represents a long vowel sound;
two circular figures printed side by side in the center upper portion of each letter that represents the / [symbol] / sound;
a “Y”-shaped figure printed in the center of each letter that represents the /a/ sound;
a circular figure printed above each letter that represents the /u:/ sound;
a square figure printed above each letter that represents the / [symbol] / sound;
a zig-zag shaped figure printed above each letter that represents the / [symbol] / sound;
a letter “u” and a triangular figure printed above said letter “u” above each letter that represents the /ju/ sound;
three horizontal lines printed in the center upper portion of each letter “y” that represents the /i/ sound;
a triangular figure printed above each letter “y” that represents the / [symbol] / sound; and
a dot printed above each letter “y” that represents the /t/ sound.

10. The printed page of claim 9 further comprising:
a dot printed in said second color to the upper left of each letter that is preceded by the / [symbol] / sound and is not preceded by a vowel letter that represents the / [symbol] / sound;
a “<”-shaped figure printed in the center of each letter “c” that represents the /k/ sound;
an “s”-shaped figure printed in the center of each letter “c” that represents the /s/ sound;
a dot printed in the upper loop of each letter “g” that represents the / [symbol] / sound;
a first line printed horizontally across the upper portion and a second line printed horizontally across the lower portion of each letter “s” that represents the /z/ sound;
a single diamond figure printed above each letter that represents the /∫/ sound;
a double diamond figure printed above each letter that represents the / [symbol] / sound;
a triple diamond figure printed above each letter that represents the / [symbol] / sound;
two vertically stacked dots printed above each letter “i” that represents the /j/ sound;
the letters “KS” printed above each letter “x” that represents the /ks/ sound;
the letters “GZ” printed above each letter “x” that represents the /gz/ sound;
the letter “Z” printed above each letter “x” that represents the /z/ sound;
the letter “t” printed to the upper right of each letter “d” that represents the /t/ sound; and
the letters “ [symbol] ” printed in place of each letter cluster “ng” that represents the / [symbol] / sound;

11. The printed page of claim 10 further comprising a set of one or more letters printed in superscript in a space between a first letter and a second letter of a word, wherein one or more sounds are pronounced between said first letter and said second letter and wherein said set of one or more letters corresponding to said one or more sounds does not appear in the conventional spelling of said word.

12. The printed page of claim 11 further comprising a horizontal line printed at the baseline of each letter cluster that represents a single sound.

13. A computer display comprising text rendered on said display, said text comprising:
letters that are silent displayed in a first color;
letters that represent the schwa sound displayed in a second color, wherein said second color is different from the first color;
letters that represent vowel sounds and do not represent the schwa sound displayed in a first set of colors, wherein said first set of colors does not include the first color or the second color; and
letters that represent rhotacized vowel sounds displayed in a second set of colors, wherein said second set of colors does not include the first color or the second color.

14. The computer display of claim 13 further comprising:
an outlined rectangular box displayed below each letter that represents a short vowel sound, wherein the outline of said rectangular box is the same color as said letter that represents a short vowel sound; and
a filled rectangular box displayed below each letter that represents a long vowel sound, wherein said filled rectangular box is the same color as said letter that represents a long vowel sound.

15. The computer display of claim 14 further comprising:
a triangular figure displayed above each letter that represents a long vowel sound;
two circular figures displayed side by side in the center upper portion of each letter that represents the / [symbol] / sound;
a “Y”-shaped figure displayed in the center of each letter that represents the /a/ sound;
a circular figure displayed above each letter that represents the / [symbol] / sound;
a square figure displayed above each letter that represents the / [symbol] / sound;
a zig-zag shaped figure displayed above each letter that represents the / [symbol] / sound;
a letter “u” and a triangular figure displayed above said letter “u” above each letter that represents the /ju/ sound;
three horizontal lines displayed in the center upper portion of each letter “y” that represents the /i/ sound;
a triangular figure displayed above each letter “y” that represents the / [symbol] / sound; and
a dot displayed above each letter “y” that represents the /ι/ sound.

16. The computer display of claim 15 further comprising:
a dot displayed in said second color to the upper left of each letter that is preceded by the / [symbol] / sound and is not preceded by a vowel letter that represents the / [symbol] / sound;
a “<”-shaped figure displayed in the center of each letter “c” that represents the /k/ sound;
an “s”-shaped figure displayed in the center of each letter “c” that represents the /s/ sound;
a dot displayed in the upper loop of each letter “g” that represents the / [symbol] / sound;
a first line displayed horizontally across the upper portion and a second line displayed horizontally across the lower portion of each letter “s” that represents the /z/ sound;
a single diamond figure displayed above each letter that represents the /∫/ sound;
a double diamond figure displayed above each letter that represents the / [symbol] / sound;
a triple diamond figure displayed above each letter that represents the / [symbol] / sound;
two vertically stacked dots displayed above each letter “i” that represents the /j/ sound;
the letters “KS” displayed above each letter “x” that represents the /ks/ sound;
the letters “GZ” displayed above each letter “x” that represents the /gz/ sound;
the letter “Z” displayed above each letter “x” that represents the /z/ sound;
the letter “t” displayed to the upper right of each letter “d” that represents the /t/ sound; and
the letters “ [symbol] ” displayed in place of each letter cluster “ng” that represents the / [symbol] / sound;

17. The computer display of claim 16 further comprising a set of one or more letters displayed in superscript in a space between a first letter and a second letter of a word, wherein one or more sounds are pronounced between said first letter and said second letter and wherein said set of one or more letters corresponding to said one or more sounds does not appear in the conventional spelling of said word.

18. The computer display of claim 17 further comprising a horizontal line displayed at the baseline of each letter cluster that represents a single sound.
